(19) United States
(12) Patent Application Publication
(10) Pub. No.: US 2010/0020728 A1
(43) Pub. Date: Jan. 28, 2010

(54) System, Method and Portable Communication Device

(76) Inventors: Todd Jefferson, Manotick (CA); Yanick Dufresne, Ottawa (CA); Tim Wilson, Nova Scotia (CA); Noam David Tomczak, Toronto (CA); Peter Macaulay, Reston, VA (US); Brad Dixon, London (CA); Alec Saunders, Manotick (CA); Howard H. Thaw, Halifax (CA)

Correspondence Address: BUCKINGHAM, DOOLITTLE & BURROUGHS, LLP, 3800 EMBASSY PARKWAY, SUITE 300, AKRON, OH, 44333-8332, US

(21) Appl. No.: 12/435,879

(22) Filed: May 5, 2009

Related U.S. Application Data
(62) Division of application No. 11/615,452, filed on Dec. 22, 2006, now abandoned.
Application No. 11/615,452 is a continuation-in-part of application No. 11/316,344, filed on Dec. 23, 2005.
(60) Provisional application No. 60/638,356, filed on Dec. 23, 2004.

(51) Int. Cl. H04L 12/16; G06F 15/16

(52) U.S. Cl. 370/260; 709/204; 455/550.1

(57) ABSTRACT

A system, method and computer program product for providing a user a way to change communications presence information is disclosed. A point of presence (PPD) device may produce presentity (a source of presence information about a user) which may be transmitted out-of-band to a watcher or watchers of an intelligent call handling presence server.

### CROSS-REFERENCE TO RELATED PATENT APPLICATIONS

This application claims priority from and is a divisional of U.S. patent application Ser. No. 11/615,452 filed on Dec. 22, 2006, which is a continuation-in-part of U.S. patent application Ser. No. 11/316,344 filed on Dec. 23, 2005, which claims priority from U.S. Provisional Patent Application Ser. No. 60/638,356 filed on Dec. 23, 2004.

### FIELD OF THE INVENTION

The present invention is related to communications, and more particularly to a method of and system for managing and routing calls and/or data between various devices.

### BACKGROUND OF THE INVENTION

### Related Art

A conventional user of telephony services may have a plurality of telephony devices. For example, a real estate sales person may have two phone lines in her home, a mobile phone, a phone at her brokerage's office, as well as a conference room phone on a third party's (such as, e.g., but not limited to, her lawyer's) location. It is conventionally difficult for the sales person to have her calls routed to her, instead, she usually may maintain multiple voicemail mailboxes at the various locations in order to ensure she receives telephone calls. Also, when she does not want to be disturbed, it is very difficult for her to screen calls, other than to either accept all or no calls by, e.g., turning off her mobile phone, or reviewing caller ID data and ignoring incoming calls. What is needed is an improved technique of controlling telephony and other communications and computing devices that overcomes shortcomings of conventional solutions.

### SUMMARY OF THE INVENTION

Various exemplary features and advantages of the invention, as well as the structure and operation of various exemplary embodiments of the invention, are described in detail below with reference to the accompanying drawings.

A system, method and computer program product for providing a user a way to change communications presence information is disclosed. A point of presence (PPD) device may produce “presentity” (a source of presence information about a user or entity) which may be transmitted out-of-band to a watcher and/or watchers of an intelligent call handling presence server.

In an exemplary embodiment, the PPD device, according to an exemplary embodiment of the present invention, may be used to set presentity information which may include, e.g., but not be limited to, availability (avail), modality of communication (mode), and/or location.

Out-of-band (OOB) signaling can be done by a variety of means according to an exemplary embodiment. According to an exemplary embodiment, the server may handle SS7 calls and VoIP seamlessly. According to an exemplary embodiment, the server may route all other types of communications as per users' directions (e.g., but not limited to, Presence, Availability and Modality), including Email, IM, Fax, Pager, etc. According to an exemplary embodiment, an exemplary server may store user contact information (from Outlook) and may use this information to route calls. According to an exemplary embodiment, the server may learn (using a knowledge base, expert system, machine learning, and/or artificial intelligence (AI)) from how a user may handle a call (accept or park or modality) and may generate rules that the user can implement (acts as a personal assistant).

Using the PPD according to an exemplary embodiment, the user may decide with whom the user may wish to speak (presence), when the user wishes to speak (selective availability), on the device of their choice (modality) in seconds (ease of use), at the user's discretion (user-centric, willingness).

This summary of the invention does not necessarily describe all features of the invention.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 presents a point of presence device according to an embodiment of the present invention;

FIG. 2 presents a block diagram of a signaling system according to an embodiment of the present invention;

FIG. 3 presents a block diagram of an intelligent call handling server signaling system according to an embodiment of the present invention;

FIG. 4 presents a block diagram of a telephony management call forwarding override system according to an embodiment of the present invention;

FIG. 5 presents a block diagram of a system in an embodiment of the present invention;

FIG. 6 presents a block diagram of an exemplary computer system that may be used in implementing an embodiment of the present invention;

FIG. 7 presents an exemplary user registration process flow according to an embodiment of the present invention;

FIG. 8 presents an exemplary process flow for a user “focus” interaction in an embodiment of the present invention;

FIG. 9 presents an exemplary process flow for a user “meeting” interaction in an embodiment of the present invention;

FIG. 10 presents an exemplary process flow for a user “at client office” interaction in an embodiment of the present invention;

FIG. 11 presents an exemplary process flow for a user “making VoIP call” interaction in an embodiment of the present invention;

FIG. 12 presents a block diagram of an interactive television (ITV) environment according to an exemplary embodiment of the present invention;

FIG. 13A presents a block diagram of an ITV device according to an exemplary embodiment of the present invention;

FIG. 13B presents a block diagram of an alternative ITV device according to an exemplary embodiment of the present invention;

FIG. 14 presents a block diagram of an exemplary architecture for a server in an embodiment of the invention;

FIG. 15 presents a flow chart of a method of setting up a conference communication in an embodiment of the invention;

FIG. 16 presents a flow chart of a method of initiating a conference communication in an embodiment of the invention;

FIG. 17 presents a state diagram of a method of manually editing a “to-call list” in an embodiment of the invention; and

FIGS. 18 and 19 present state diagrams of a method of implementing a “watcher” system in an embodiment of the invention.

### DETAILED DESCRIPTION OF EXEMPLARY EMBODIMENTS OF THE PRESENT INVENTION

A preferred embodiment of the invention is discussed below as well as various other exemplary, but non-limiting embodiments. While specific implementations are discussed, it should be understood that this is done for illustration purposes only. A person skilled in the relevant art will recognize that other components and configurations may be used without parting from the spirit and scope of the invention.

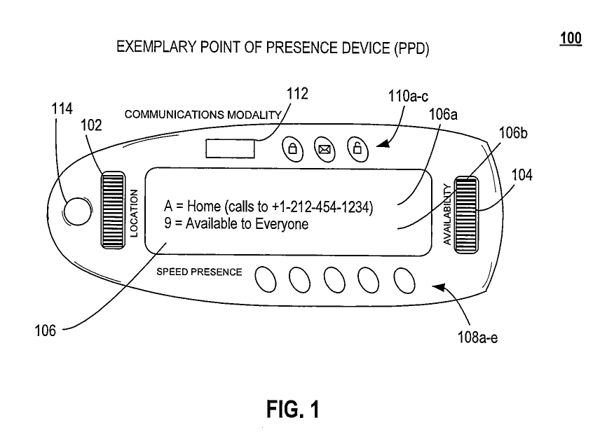

FIG. 1 presents an exemplary embodiment of the present invention including a point-of-presence device (PPD) 100. In an exemplary embodiment, the PPD 100 may include one or more input and output devices as well as signal communication capabilities. In an exemplary embodiment, PPD 100 may include, for example, but not limited to, and not required, a location selector 102, an availability selector 104, a communications modality selector 112, and a display 106. In an exemplary embodiment, the PPD 100 may further include one or more buttons 110 a-c which may be used, e.g., but not limited to, and not required, to lock 110a the PPD 100, to access email 110b, to set encryption level 110c, etc. PPD 100, in an exemplary embodiment may be used to select a presence for a user of PPD 100. The presence, in an exemplary embodiment may include a location, and availability, which may include a selected communications modality as well. In one exemplary embodiment, a PPD 100 may initialize with a default presence. In another exemplary embodiment, the PPD 100 may be initialized by a user selection of a selected presence. In an exemplary embodiment, a number of preset speed presences may be set on PPD 100, as shown and referenced as speed preference buttons 108a-e.

The PPD 100 device should preferably have a small form factor, e.g., the size of a key, or watch fob, in the interest of user convenience and portability. In one exemplary embodiment, the PPD 100 may be adapted to be physically coupled to a lanyard, chain, other devices or similar item via coupling hole 114, or other couplers as will be apparent to those skilled in the relevant art. In an exemplary embodiment, a current presence, initialized presence, or selected presence may be displayed on display 106. In an exemplary embodiment, selections of, e.g., but not limited to, and not required, a location designation 106a, in this case a letter designating home, and an availability designation 106b, in this case a number designating availability to be reached by anyone.

In another exemplary embodiment, other information may be displayed, such as, e.g., but not limited to, any of various communications modality, including, e.g., but not limited to, a plain old telephone system (PSTN) phone, a voice over Internet Protocol (VoIP) phone or device, an communications device or computing device (such as, e.g., but not limited to, a processor, a computer, a personal computing device, a mobile device, a mobile phone, a personal digital assistant (PDA), a handheld, desktop, server, laptop, mobile, an interactive television (ITV) device, an Internet telephony device, a wired device, a wireless device, a CATV device, a blue tooth, WiFi, WiMax, PSTN, CDMA, TDMA, iDEN, iBurst, a signaling device, etc.)

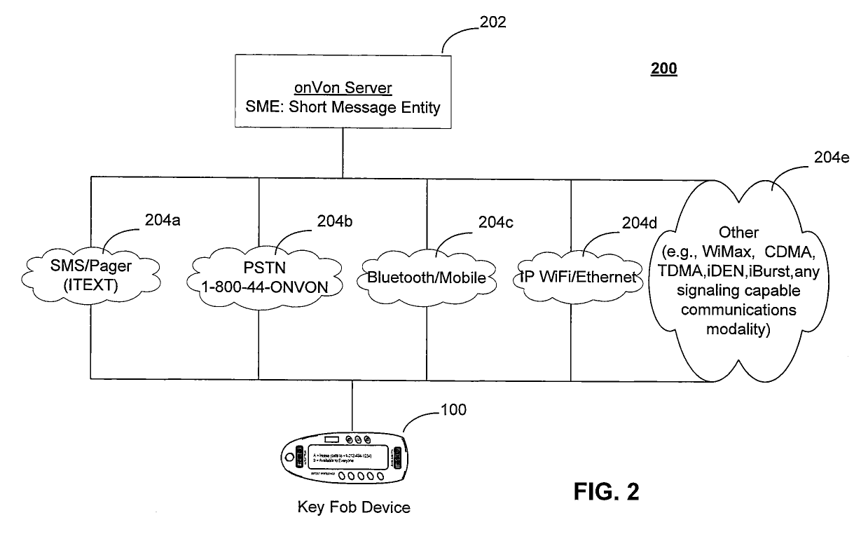

FIG. 2 presents an exemplary embodiment of a communications architecture 200, including, in an exemplary embodiment, various exemplary out-of-band (OOB) messaging modalities 204a-204e over which PPD 100 may communicate out-of-band from an exemplary intelligent call handling server 202. In an exemplary embodiment, PPD 100 may communicate over a single communications modality 204a-e. In another exemplary embodiment, the PPD 100 may be adapted to communicate over more than one of the exemplary communications modalities 204a-e.

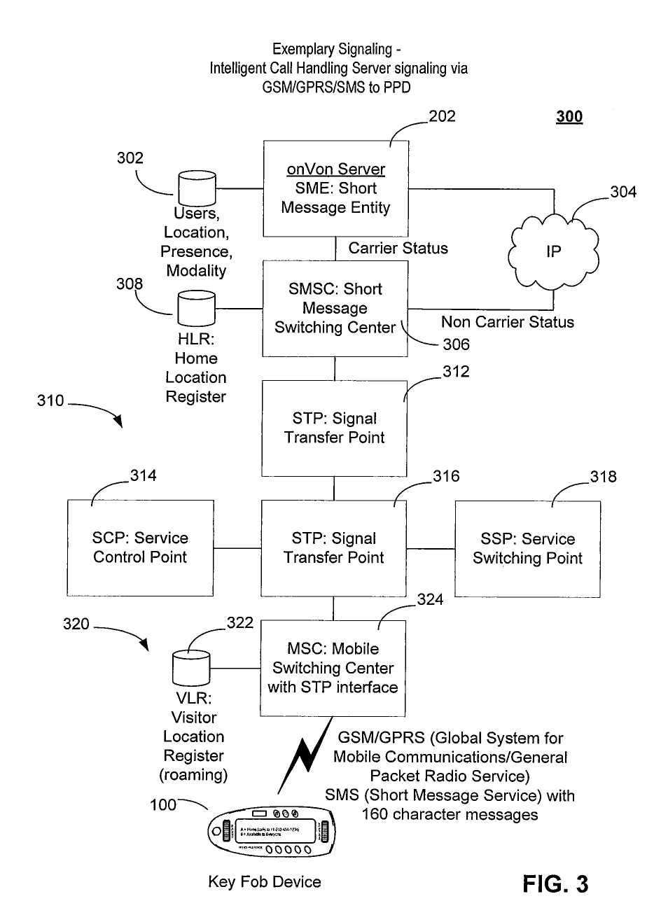

FIG. 3 presents an exemplary embodiment of a diagram 300 illustrating an exemplary signaling system. In an exemplary embodiment of diagram 300, PPD 100 may communicate via, e.g., but not limited to, a global system for mobile communications (GSM)/global packet radio service (GPRS)/short message service (SMS), to a mobile switching center (MSC) system 320 including MSC 324 and VLR 322 (visitor location register) storage. In an exemplary embodiment, MSC 324 may include an STP interface and may be used to communicate with a signaling system 310. The signaling system 310 may be the signaling system seven (SS7) signaling system commonly used for call signaling in the PSTN. From the signaling system 310, signaling may be communicated via a short message switching center 306 and the HLR (home location register) 308, to the intelligent call handling server 202 and the user, location, presence and modality storage 302. Communication may occur over an IP network 304.

FIG. 3 includes a Signaling System 7 (SS7) signaling network 310. Signaling network 310 illustrates an exemplary signaling network. The SS7 network is a separate network conventionally used to handle the set up, tear down, and supervision of telephone calls between calling party and called party. Signaling network 310 in the given example is the Signaling System 7 (SS7) network. Signaling network 310 may include service switching points (SSPs) 318, signal transfer points (STPs) 312, 316, and service control point (SCP) 314.

In the SS7 network, the SSPs are the portions of the backbone switches providing SS7 functions. The SSPs can be, for example, a combination of a voice switch and an SS7 switch, or a computer connected to a voice switch. The SSPs may communicate with the switches using primitives, and may create packets for transmission over the SS7 network.

The STPs may act as routers in the SS7 network, typically being provided as adjuncts to in-place switches. The STPs route messages from originating SSPs to destination SSPs. Architecturally, STPs can and are typically provided in “mated pairs” to provide redundancy in the event of congestion or failure and to share resources (i.e., load sharing is done automatically). STPs can be arranged in hierarchical levels, to provide hierarchical routing of signaling messages. For example, mated STPs 312 and 316 may be at a first hierarchical level, while other mated STPs may be at a second hierarchical level.

SCPs may provide database functions. SCPs can be used to provide advanced features in an SS7 network, including routing of special service numbers (e.g., 800 and 900 numbers), storing information regarding subscriber services, providing calling card validation and fraud protection, and offering advanced intelligent network (AIN) services. SCP 314 is connected to mated STPs 312 and 316.

In the SS7 network, there are unique links between the different network elements. Table 1 provides definitions for common SS7 links.

TABLE 1

| SS7 link | |
|---|---|
| terminology | Definitions |
| Access (A) links | A links connect SSPs to STPs, or SCPs to STPs, |
| | providing network access and database access through |
| | the STPs. |
| Bridge (B) links | B links connect mated STPs to other mated STPs. |
| Cross (C) links | C links connect the STPs in a mated pair to one |
| | another. During normal conditions, only network |
| | management messages are sent over C links. |
| Diagonal (D) | D links connect the mated STPs at a primary |
| links | hierarchical level to mated STPs at a secondary |
| | hierarchical level. |
| Extended (E) | E links connect SSPs to remote mated STPs, and are |
| links | used in the event that the A links to home mated STPs |
| | are congested. |
| Fully associated | F links provide direct connections between local SSPs |
| (F) links | (bypassing STPs) in the event there is much traffic |
| | between SSPs, or if a direct connection to an STP is |
| | not available. F links are used only for call setup and |
| | call teardown. |

For a more detailed description of SS7 network topology, the reader is referred to Russell, Travis, Signaling System #7, McGraw-Hill, New York, N.Y. 10020, ISBN 0-07-0549915, which is incorporated herein by reference in its entirety.

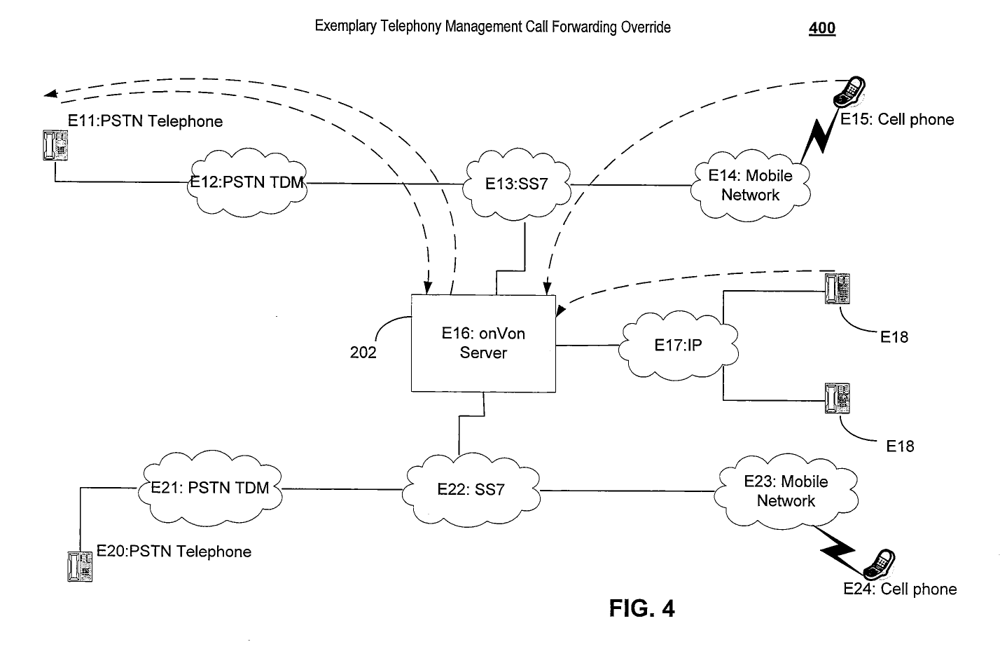

FIG. 4 presents an exemplary embodiment of a diagram 400 illustrating an exemplary telephony management call forwarding override example. According to an exemplary embodiment, a user on, e.g., but not limited to, a PSTN phone E11 may communicate to call handling presence server 202 via PSTN TDM (Time Domain Multiplexed) E12 and SS7 network E13 to setup, or override call forwarding setting of various other communications devices associated with the user, such as, e.g., mobile communications device E15, or VoIP device E18. As shown in FIG. 4 the mobile communications device E15 is interconnected with the SS7 network E13 via the mobile network E14. The VoIP device E18 is interconnected with the on Von server E16 via the IP network E17. Calls originating from another communications device, such as, e.g., but not limited to, PSTN phone E20, or mobile device E24 and destined for, e.g., but not limited to, mobile device E15, or VoIP device E18, may be rerouted via call handling presence server 202 to PSTN phone E11. The PSTN phone E20 and mobile device E24 may be on the same networks as their counterparts E11 and E15, or on physically separate networks: PSTN TDM E21, SS7 E22 and mobile network E23. The call setup signaling may be set up via out-of-band (OOB) signaling PPD 100 and may automatically provision the call forwarding from the devices E15, E18.

In other words, in this embodiment, the call handling presence server 202 is sending signals to the PSTN to set up call forwarding on the PSTN itself. An alternative is to treat the PSTN, and all of the other communication networks as well, as simple communication channels, leaving all of the intelligence and doing all of the routing at the call handling presence server 202 itself. Though calls will take longer paths, this simplifies the interface between the system and the rest of the world because the call handling presence server 202 only needs to know how to place simple calls and does not need to know any more of the intricacies about the outside networks.

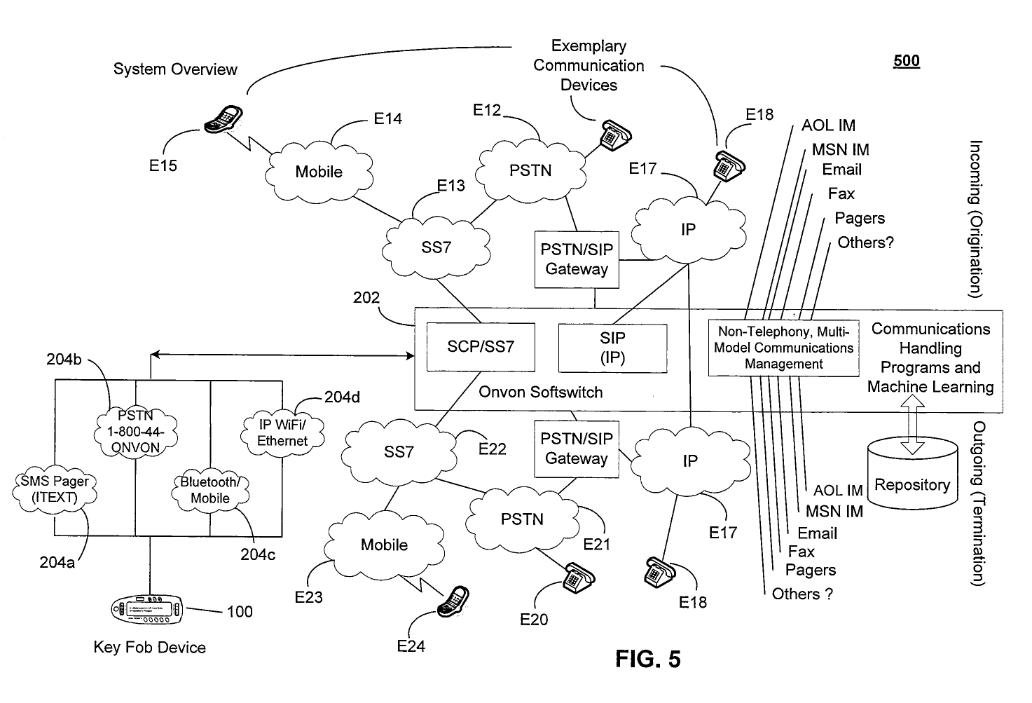

FIG. 5 presents a block diagram of an exemplary system environment 500 whereby a user may be able to manage presence using an OOB PPD 100.

System overview 500 may demonstrate exemplary telephone call handling from origination to termination. The signaling initialization and changes may be handled out-of-band via an exemplary PPD 100. Signaling may occur, e.g., as shown in FIG. 3 in one exemplary embodiment.

In an exemplary embodiment, the system may use artificial intelligence to analyze behaviour of the user so as to provide suggested or optimized provision of service.

In another exemplary embodiment, when a user selects a change to presence via PPD 100, the call handling presence server 202 may provide confirmation to the user of the change of presence.

In one exemplary embodiment, the PPD 100 may communicate over secure communications. In an exemplary embodiment, the communication may be encrypted. In another exemplary embodiment, the communication may require user authentication to ensure the user of the device is the valid user. Various encryption, security, and authentication systems may be used as will be apparent to those skilled in the relevant art.

FIG. 5 may further include multi-mode communication and collaboration. In an exemplary embodiment, various multi-mode communication and collaboration may be handled, such as conference calls. In an exemplary embodiment, the present invention may be used to extend call handling to other systems including, e.g., but not limited to, an instant messaging (IM), or an electronic mail (e-mail) system, Paging systems, Fax, etc. An exemplary IM system may include, e.g., but not limited to, an AOL™ Instant Messenger, an MS™ Messenger, Yahoo!™ Messenger, and others.

Devices may communicate via a communications link via any of a number of well known protocols such as, e.g., but not limited to, simple mail transport protocol (SMTP), hyper text markup protocol (HTTP), Internet Protocol (IP), transmission control protocol/IP (TCP/IP), etc.

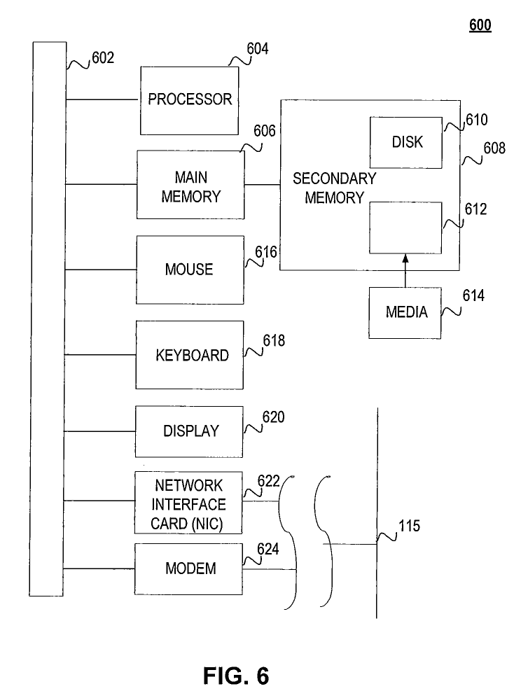

FIG. 6 presents an exemplary computer system that may be used in implementing an exemplary embodiment of the present invention. Specifically, FIG. 6 presents an exemplary embodiment of a computer system 600 that may be used in computing devices such as, e.g., but not limited to, PPD 100, call handling presence server 202, or other similar computer or server-type component of the system, etc. according to an exemplary embodiment of the present invention. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein.

Specifically, FIG. 6 illustrates an exemplary computer 600, which in an exemplary embodiment may be, e.g., (but not limited to) a personal computer (PC) system running an operating system such as, e.g., (but not limited to) MICROSOFT™ WINDOWS™ NT/98/2000/XP/CE/ME/etc. available from MICROSOFT Corporation of Redmond, Wash., U.S.A. However, the invention need not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, fat clients, proxy servers, network communication servers, remote access devices, client computers, server computers, routers, web servers, data, media, audio, video, telephony or streaming technology servers, etc., may also be implemented using a computer such as that shown in FIG. 6. Services may be provided on demand using, e.g., but not limited to, an interactive television (iTV), a video on demand system (VOD), and via a digital video recorder (DVR), or other on demand viewing system.

The computer system 600 may include one or more processors, such as, e.g., but not limited to, processor(s) 604. The processor(s) 604 may be connected to a communication infrastructure 602 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 600 may include a display interface that may forward, e.g., but not be limited to, graphics, text, and other data, etc., from the communication infrastructure 602 (or from a frame buffer, etc., not shown) for display on the display unit 620.

The computer system 600 may also include, e.g., but may not be limited to, a main memory 606 such as, random access memory (RAM), and a secondary memory 608, etc. The secondary memory 608 may include, for example, (but not be limited to) a hard disk drive 610 and/or a removable storage drive 612, representing a floppy diskette drive, a magnetic tape drive, an optical disk drive, a compact disk drive CD-ROM, etc. The removable storage drive 612 may, e.g., but not limited to, read from and/or write to a removable storage media 614 in a well known manner. Removable storage media 614, also called a program storage device or a computer program product, may comprise, e.g., but not be limited to, a floppy disk, magnetic tape, optical disk, compact disk, etc. which may be read from and written to by removable storage drive 612. As will be appreciated, the removable storage media 614 may include a computer usable storage medium having stored therein computer software and/or data.

In alternative exemplary embodiments, secondary memory 610 may include other similar devices for allowing computer programs or other instructions to be loaded into computer system 600. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to computer system 600.

Computer 600 may also include an input device such as, e.g., (but not limited to) a mouse 616 or other pointing device such as a digitizer, and a keyboard 618 or other data entry device.

Computer 600 may also include output devices, such as, e.g., (but not limited to) display 620, and a display interface. Computer 600 may include input/output (I/O) devices such as, e.g., (but not limited to) a communications interface, cable and a communications path, etc. These devices may include, e.g., but not be limited to, a network interface card 622, modem 624 and external communication lines or cables 115. Communications interface 624 may allow software and data to be transferred between computer system 600 and external devices.

In this document, the terms “computer program medium” and “computer readable medium” may be used to generally refer to media such as, e.g., but not limited to removable storage drive 612, a hard disk installed in hard disk drive 610, and signals, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory and may include at least microprocessors, microcontrollers, digital signal processors (DSPs) and similar ASICs (application specific integrated circuits). A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc. The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art. The embodiments of the invention may be executed by a computer processor or similar device programmed in the manner of method steps, or may be executed by an electronic system provided with means for executing these steps. Similarly, an electronic memory medium such as computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

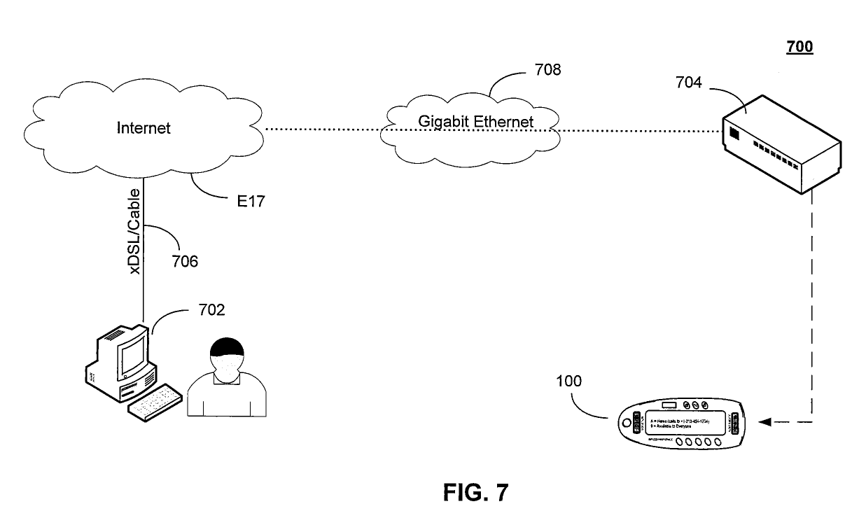

FIG. 7 presents a process flow diagram 700 illustrating an exemplary user registration using a PPD 100, which may in one embodiment be a software application running on a PC 702 allowing setting, and changing of presence by a user. The user registers for the on Von service using his or her PC 702, accessing the on Von server 704 via the Internet E17. The PC 702 may be connected to the Internet E17 in various ways including via xDSL/Cable 706 as shown. Similarly, the on Von server 704 may be connected to the Internet E17 in various ways including via a Gigabit Ethernet connection 708 as shown. Once the user has performed the one-time set up, the PPD 100 with SIM card (a key fob) is sent to the user by courier.

An exemplary embodiment of the present invention may include an artificial intelligence (AI) (or machine assisted learning system) to learn (or discern) a user's preferences and rules for call handling based on their interaction with the system. The system may access a database of call handling transactions, and from that learn who calls the user and how the user interacts with the caller such as, e.g., but not limited to, placing in voice mail, accepting calls only during the day, etc. The system may act as an automated administrative assistant or secretary, understanding a user's preferred call routing. The call handling presence server 202 becomes the AI assistant, able to learn which callers may be important or infer that if we identify someone from a given company as someone on a work list, all email addresses from the domain of that company, appearing in a contact list system may be assigned to a work category, or list. In setup of locations, a location may be home, work, etc., and a list of users' callers may be associated as permitted for availability selection at a particular location and/or availability level.

The intelligent call handling presence server 202 may in an exemplary embodiment, interact with inbound calls. Further, the call handling presence server 202 can interact with outbound calls.

Referring again to FIG. 5, diagram 500 illustrates another aspect of an exemplary embodiment of the present invention. In an exemplary embodiment, the system 500 may include a database as, e.g., a preference serialization repository. The database, in an exemplary embodiment, may store meta data about the user. Meta data may include, in an exemplary embodiment, for example, but not limited to, information on location, availability and modality preferences and rules. In an exemplary embodiment, availability, modality and location may be referred to as “Avail, mode, and location” and/or presentity. Meta data may also include a contact list, and caller ID parsing data, which may direct the transfer of a specific caller to voicemail (if a user A calls, send the user A to voicemail) or permit the phone to ring, in another exemplary embodiment. Further, meta data may include, e.g., but not limited to, Geo Location information, messaging preferences, and/or information display preferences.

In an exemplary embodiment, geo-location information meta data may be used to determine the position of the caller. In an exemplary embodiment, geo-location information may be obtained from any known positioning system, such as, for example, a global positioning system (GPS). Geo-location information may be used to indicate the coordinates of the user. For example, coordinates obtained from the positioning system may be used to distinguish between work, home, or the client site. The system may use the geo-location information to apply preferences of the user for that particular location. For example, at the office, the user may screen calls from the user's friends, but may permit the calls when the user is at home.

Geo-location data may also be analyzed to detect changes in location or determine the physical speed of the user. If, for example, it is detected that the user is moving at a rate of 90 km per hour, it may be determined that the user is travelling in a passenger vehicle. Similarly, if the user is moving constantly at a rate of 5 km per hour, it might be determined that the user is jogging and therefore will have limited access to his communication devices, or at least limited interest in picking up calls or emails. These determinations are considered part of the user's context and will govern which call-management rules are invoked.

Geo-location data can also be integrated with mapping software to determine where the user might be located with respect to roads and landmarks. Knowing the user's location with respect to streets, buildings and/or businesses can be useful in many ways, for example, providing directions on how to reach a client meeting, or identifying a nearby restaurant.

Meta data may also store information on messaging preferences as part of contact information. For example, a user may select messaging preferences of the user to indicate that if person X sends an email, the user may send a voicemail and copy or cc the message to person X's email address

In another exemplary embodiment, meta data may also permit a user to implement information display preferences for the PPD 100 display 106. The PPD display 106 may present to the user personalized information based on their information display preferences. The user may personalize the user's information display preferences by, for example, selecting favourite weather, news, sports, etc., to be displayed on the PPD display 106. Using the information display preferences, the PPD 100 system may use idle packets or extra space to deliver information to the PPD 100 device.

Additionally, in an exemplary embodiment, the PPD 100 or the PPD system may also automatically track and predict user preferences regardless of whether the user makes selections indicating their information display preferences. In this exemplary embodiment, the system may use machine assisted learning, which may also be identified as artificial intelligent (AI). According to a user's interaction with the system, the PPD device or the PPD system may develop and identify the user's preferences and rules for call handling based on their interaction with the system. The system may maintain a data base of call handling transactions. Call handling instructions may be used to identify individuals who call the user and to determine how the user reacts to receiving a call from a particular caller to set up how to interact with all inbound calls and to screen the callers. For example, the system may determine that the user typically sends the call from a particular caller to voice mail, or only takes it during the day, etc. Based on the observed behaviour of the user, the system may propose certain provision of services.

In an exemplary embodiment, the system may be able to identify callers of particular importance or to determine that if the user identifies someone from a particular company as being someone on the user's work list, then all emails from that company in the user's contact manager, for example, may be assigned to the work list. Additionally, in an exemplary embodiment, the system may also identify that if someone calls regularly, either from the work list or otherwise, then the system may determine that a caller is important and may enable the caller's calls to go through more readily to the user. For example, if identified as an important caller, a call may be routed to the user even when normally outside a user's presence, such as, for example, when the user is in the car on the way to work, or later at night, etc.

Referring to FIG. 5, in diagram 500, the present embodiment may also be used for processing outbound calls. The PPD 100 or the PPD system may include an executive assistant module. The executive assistant module in an exemplary embodiment may use multi-mode out-of-band (OOB) signalling. The executive assistant module may allow the user to use the PPD 100 to provide a signal to a switch of call handling presence server 202 handling the call when the call is in progress, to handle the call, or to change the call characteristics (e.g., turn off call waiting, etc.). Using the PPD 100 (the fob), (and the soft keys with the thumb wheels), the PPD 100 may signal the switch of call handling presence server 202 to perform certain functions. The functions may include, e.g., but not limited to, adding another caller, transferring a call, moving a call from land line to cell line, etc. This may be done with the PPD display 106 and a code on the fob, using, e.g., buttons and/or selectors 102, 104, 108 a-c, 110 a-c, 112. The PPD device 100 may use a softswitch in the hand off of transport, or at the edge of network. Use of a softswitch for setting up transport of a VoIP call will be apparent to those skilled in the relevant art. The PPD 100 may perform any functions if it is, for example, an analog telecommunications adapter (ATA) and thus in on the call, or the PPD 100 may signal the intelligent call handling presence server 202 to perform the requested function.

In an exemplary embodiment, modality of communication may refer to a user's selected method of communication with others. A modality of communication may include, e.g., but not limited to, mobile/landline/IP phones, IM, Email, Fax, paging device, etc.

In an exemplary embodiment, PPD 100 may be a fob. In an exemplary embodiment, the PPD 100 may be a small device. The PPD 100 may be of substantially low mass (light weight) and minimal dimensions. In an exemplary embodiment, the PPD 100 may include a mechanism 114 to attach to a key ring. Mechanism 114 may allow a user to consider attaching the PPD 100 to a key ring, thus a key ring fob or a key fob. In an exemplary embodiment, the dimensions may be the width and depth similar to a automobile door opening key ring PPD device. In an exemplary embodiment, the length of the PPD may be longer than such an automotive fob.

In an exemplary embodiment of the present invention, the system may further include a handler, also referred to as a watcher. In another exemplary embodiment, the system may include intelligent learning capability. In an exemplary embodiment, the system may further include a repository, such as a database (db) repository.

In an exemplary embodiment, the PPD 100 device may produce presentity (a source of presence information about a user) which may be transmitted out-of-band to a watcher or watchers of an intelligent call handling presence server 202.

The call handling servers 202 may maintain information provided by the subscriber user via, e.g., a web (or otherwise) provision interface which may be updated with messages from the PPD 100 device.

In an exemplary embodiment, user information (such as, e.g., but not limited to, contacts, etc.) may be uploaded to the call handling presence server 202. Such information may be uploaded via, e.g., but not limited to, an applet on a user's machine from, e.g., but not limited to, their contact manager, personal information manager (PIM), such as, e.g., but not limited to, MICROSOFT™ OUTLOOK™). In an exemplary embodiment, such information may include, e.g., but not limited to:

Contacts may be automatically (or via, e.g., but not limited to, single-button press) uploaded to, e.g., but not limited to, call handling server 202;

The call handling server 202 may stratify contacts based on, e.g., but not limited to, common characteristics (such as, e.g., but not limited to, all emails ending in a particular domain name (e.g., @agovo.com) are work colleagues);

Develop (e.g., but not limited to, suggest) rules to manage calls;

As new contacts get added, e.g., but not limited to, they may be reviewed;

Calendar may be automatically (or, e.g., but not limited to, using a single-button press) uploaded to call handling server 202;

Call handling server 202 may send notifications and reminders to appointments (as may be desired); and/or

Initiate calls to conference call bridges as required.

Calendar information may be used, in an exemplary embodiment, to track with whom a user may be meeting. This is done by integrating with external calendar or scheduling software which may for example, be supported by a local PC, local server, or an online service.

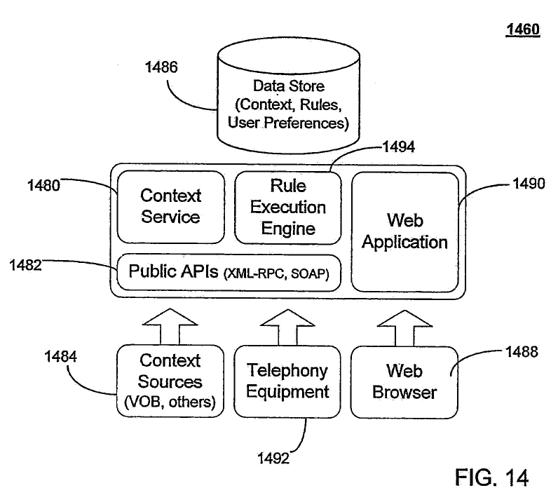

An exemplary architecture of a server for call handling and presence in an embodiment of the invention is presented in FIG. 14. This server may perform any or all of the following functions:

examine the user's context stored in a local database;

update the user's context in accordance with scheduling data collected from the user's personal information manager (PIM) server;

capture call requests from the local email server and local voicemail, forwarding them to the user's client software so that the calls can be entered into the user's calling list (though this functionality could be placed elsewhere, for example, in the local email server and local voicemail themselves);

update the user's presence in accordance with data collected from a local email server, the local telephone switch and other devices; and

communicate with other relevance engine servers to share presence, willingness and context information. (It is expected that presence will often come from Instant messaging clients or from their network servers, so communication will typically be required with those presence sources as well.)

In an exemplary embodiment this server 1460 may be constantly monitoring and/or being updated with the users' context sources (for example, their calendar in Exchange) for relevant changes. The Context Service module 1480 exposes context from heterogeneous sources in a consistent manner, so other services can easily get access to relevant context information. Potential context sources 1484 include email, contacts, calendar, time-of-day, presence clouds like Microsoft Live Communications Server, LDAP directories, and location services. The Context Service module 1480 may communicate with the different context sources 1484 via public APIs (application programming interfaces) 1482. Some of the context related information is cached in the Data Store 1486 in order to improve performance.

The context information may be used by a Presence Aggregator Service to determine the user's effective presence based on heuristics and context data. For example, when a user's calendar indicates that they are currently in a meeting, the system may automatically update the user's presence to reflect that they are busy. The system achieves this by accessing the calendaring information using an adapter for that source of context. The current presence is published to the outside world using an appropriate protocol, which could include but not be limited to SIP/SIMPLE or XMPP. The granularity of the presence data exposed to external users is controlled through privacy policies.

Using the system Client, the user may add, delete or edit rules that determine how incoming calls are handled. These rules use a user's current context and the caller information to determine what action to take (e.g. Accept, decline or redirect the call). In an embodiment of the invention, the user may use the rules editor interface to add, modify, delete and prioritize rules to control calls.

Using the Rules Editor the user may specify what to do when a call arrives based on the evaluation of one or more conditions. These conditions can be selected based on who is calling, the time of day, the day of the week and other similar contextual sources of information. In an embodiment of the invention the rules editor is used to add, delete, modify and prioritize the rules in effect for that user.

The user communicates with the Data Store 1486, where all rules data is stored, via his Web browser 1488 and the Web application 1490. The Administrator may access the system in the same manner, to setup users and to configure the various sources of context information.

In an embodiment of the invention, when a call comes in from the external telephony equipment 1492, the public APIs 1482 receive the incoming call and pass the information (such as a display name, uri and subject from an SIP INVITE) to the Rules Execution Engine 1494. The Rules Execution Engine 1494 requests current presence information from the Data Store 1486 and rich contact information from the Context Provider Service 1480. Using the current context, the rich contact information and the database of rules, the Rules Execution engine 1494 responds to the external telephony equipment 1492.

The database may be stored on the intelligent call handling presence server 202. In an exemplary embodiment, the database schema may include, e.g., but not limited to:

First Name, Last Name=character string

SIM (Subscriber Identity Module)=hexadecimal value

Presence entity=“pres:someone@example.com” will be derived from the

GSM/GRPS SIM (Subscriber Identity Module)

timestamp=last communication YYYY-MM-DD-HH-MM-SS-MMM

last web access=YYYY-MM-DD-HH-MM-SS-MMM

last web update=YYYY-MM-DD-HH-MM-SS-MMM

sequence=numbered messages from PPD 100 to watcher

status=open, closed

location=A, B, C, . . .

availability=0, 1, 2, . . .

modality=POTS, EMAIL, SMS, VoIP, . . .

contact priority=9.9

contact methods=home, office, cell, . . . email, SMS, IM

note=any textual message . . . “I'm in NYC next week”

who-can-see-me-where=contacts who can see my location

who-can-see-me-how=contacts who can see my method of access

Unlike find-me-follow-me solutions, or personal assistant applications, which route telephone calls to you with very little intelligence, the system and method of the invention allows users to define rules for controlling all manners of real time communications based on a number of contextual criteria including the following:

Presence;

Day and Time;

relationship to the caller (for example, the authentication level of the calling party);

Current activity;

Who is calling;

What the call is about;

Importance of the call;

PC activity (detecting use of the mouse, detecting certain applications; for example, if the user is running a slide show in MS Powerpoint, it may be decided not to interrupt the user);

detecting conversation at the PPD;

detecting proximity to a Bluetooth, WiMax, WiFi or CDMA transceiver;

Communication history with caller;

Velocity of user (driving, running etc.);

Refer information (whether the call is being transferred by someone else);

Mood of user;

Ambient noise; and

Location of user (can, for example, be implied by the device used, such as a desktop telephone, be determined by the base station that a portable device is communicating through, using GPS, by triangulation or other technologies.)

Physical presence alone is not context. The less contextually aware, the less automated control can be. Knowing the physical presence state of a contact is a first step, but contextual awareness requires a lot more than physical presence. Contextual awareness is the set of facts or circumstances that surround a situation. Contextual awareness represents the awareness of the applications of the context based on factors including: physical presence, day and time, current activity, who is calling, what the call is about, environment, place, relationship and caller preferences. Users can define rules for managing telecommunications based on a number of contextual criteria.

For example, a user may be in a meeting with a co-worker. He may wish to be available to his boss or other co-workers, but wish to avoid being interrupted by his friends outside the company. He may wish to be available to closer personal contacts such as his spouse, provided that the matter is urgent enough to warrant interrupting the meeting with the co-worker. The system of the invention takes into account all of these factual details and applies them to the user's set of rules to determine whether he should be interrupted, and if so, in what manner.

While various exemplary embodiments of the present invention have been described above, it will be apparent to persons skilled in the art that a number of variations and modifications can be made without departing from the scope of the invention.

Table 2 lists a number of terms that are used in the description of the exemplary use cases that follow. It is understood that these are working definitions for the purpose of describing these examples, and these definitions are not intended to be limiting on the invention itself.

TABLE 2

| Term | Definition |
|---|---|
| access tandem (AT) | An AT is a class ¾ switch used to switch calls between |
| | EOs in a LATA. An AT provides subscribers access to the |
| | IXCs, to provide long distance calling services. An access |
| | tandem is a network node. Other network nodes can |
| | include, for example, a CLEC, or other enhanced services |
| | provider (ESP), an international gateway or global point-of- |
| | presence (GPOP), or an intelligent peripheral(IP). |
| bearer (B) channels | Bearer (B) channels are digital channels used to carry both |
| | digital voice and digital data information. An ISDN bearer |
| | channel is 64,000 bits per second, which can carry PCM- |
| | digitized voice or data. |
| called party | The called party is the caller receiving a call sent over a |
| | network at the destination or termination end. |
| calling party | The calling party is the caller placing a call over any kind of |
| | network from the origination end. |
| central office (CO) | A CO is a facility that houses an EO homed. EOs are often |
| | called COs. |
| class 1 switch | A class 1 switching office, the Regional Center(RC), is the |
| | highest level of local and long distance switching, or “office |
| | of last resort” to complete a call. |
| class 3 switch | A class 3 switching office was a Primary Center (PC); an |
| | access tandem (AT) has class 3 functionality. |
| class 4 switch | A class 4 switching office was a Toll Center (TC) if |
| | operators were present or else a Toll Point (TP); an access |
| | tandem (AT) has class 4 functionality. |
| class 5 switch | A class 5 switching office is an end office (EO) or the |
| | lowest level of local and long distance switching, a local |
| | central office. The switch closest to the end subscriber. |
| competitive LEC | CLECs are telecommunications services providers of local |
| (CLEC) | services that can compete with ILECs. !nterprise and |
| | Century 21 are examples. A CLEC may or may not handle |
| | IXC services as well. |
| competitive access | Teligent and Winstar are examples. |
| providers (CAPS) | |
| customer premises | CPE refers to devices residing on the premises of a |
| equipment (CPE) | customer and used to connect to a telephone network, |
| | including ordinary telephones, key telephone systems, |
| | PBXs, video conferencing devices and modems. |
| digitized data (or | Digitized data refers to analog data that has been sampled |
| digital data) | into a binary representation (i.e., comprising sequences of |
| | 0's and 1's). Digitized data is less susceptible to noise and |
| | attenuation distortions because it is more easily regenerated |
| | to reconstruct the original signal. |
| egress end office | The egress EO is the node or destination EO with a direct |
| | connection to the called party, the termination point. The |
| | called party is “homed” to the egress EO. |
| egress | Egress refers to the connection from a called party or |
| | termination at the destination end of a network, to the |
| | serving wire center (SWC). |
| end office (EO) | An EO is a class 5 switch used to switch local calls within a |
| | LATA. Subscribers of the LEC are connected (“homed”) to |
| | EOs, meaning that EOs are the last switches to which the |
| | subscribers are connected. |
| Enhanced Service | A network services provider. |
| Provider (ESP) | |
| equal access | 1+ dialing as used in US domestic calling for access to any |
| | long distance carrier as required under the terms of the |
| | modified final judgment (MFJ) requiring divestiture of the |
| | Regional Bell Operating Companies (RBOCs) from their |
| | parent company, AT&T. |
| global point of | A GPOP refers to the location where international |
| presence (GPOP) | telecommunications facilities and domestic facilities |
| | interface, an international gateway POP. |
| incumbent LEC | ILECs are traditional LECs in the US, which are the |
| (ILEC) | Regional Bell Operating Companies (RBOCs). Bell South |
| | and US West are examples. ILEC can also stand for an |
| | independent LEC such as a GTE. |
| ingress end office | The ingress EO is the node or serving wire center (SVC) |
| | with a direct connection to the calling party, the origination |
| | point. The calling party is “homed” to the ingress EO. |
| ingress | Ingress refers to the connection from a calling party or |
| | origination. |
| integrated service | An ISDN Basic Rate Interface (BRI) line provides 2 bearer |
| digital network | B channels and 1 data D line (known as “2B + D” over one or |
| (ISDN) basic rate | two pairs) to a subscriber. |
| interface (BRI) line | |
| integrated services | ISDN is a network that provides a standard for |
| digital network | communications (voice, data and signaling), end-to-end |
| (ISDN) | digital transmission circuits, out-of-band signaling, and a |
| | features significant amount of bandwidth. |
| inter machine trunk | An inter-machine trunk (IMT) is a circuit between two |
| (IMT) | commonly-connected switches. |
| inter-exchange carrier | IXCs are US domestic long distance telecommunications |
| (IXC) | services providers. AT&T, MCI and Sprint are examples. |
| internet protocol (IP) | IP is part of the TCP/IP protocols. It is used to recognize |
| | incoming messages, route outgoing messages, and keep |
| | track of Internet node addresses (using a number to specify |
| | a TCP/IP host on the Internet). IP corresponds to the |
| | network layer of OSI. |
| Internet service | An ISP is a company that provides Internet access to |
| provider (ISP) | subscribers. |
| ISDN primary rate | An ISDN Primary Rate Interface (PRI) line provides the |
| interface (PRI) | ISDN equivalent of a T1 circuit. The PRI delivered to a |
| | customer's premises can provide 23B + D (in North |
| | America) or 30B + D (in Europe) channels running at 1.544 |
| | megabits per second and 2.048 megabits per second, |
| | respectively. |
| local exchange carrier | LECs are local telecommunications services providers. Bell |
| (LEC) | Atlantic and US West are examples. |
| local access and | A LATA is a region in which a LEC offers services. There |
| transport area | are over 160 LATAs of these local geographical areas |
| (LATA) | within the United States. |
| local area network | A LAN is a communications network providing connections |
| (LAN) | between computers and peripheral devices (e.g., printers |
| | and modems) over a relatively short distance (e.g., within a |
| | building) under standardized control. |
| modified final | Modified final judgment (MFJ) was the decision requiring |
| judgment (MFJ) | divestiture of the Regional Bell Operating Companies |
| | (RBOCs) from their parent company, AT&T. |
| network node | A network node is a generic term for the resources in a |
| | telecommunications network, including switches, DACS, |
| | regenerators, etc. Network nodes essentially include all non- |
| | circuit (transport) devices. Other network nodes can |
| | include, for example, equipment of a CLEC, or other |
| | enhanced service provider (ESP), a point-of-presence |
| | (POP), an international gateway or global point-of-presence |
| | (GPOP). |
| new entrant (NE) | A new generation global telecommunications. |
| next generation | A new telecommunications services provider, especially IP |
| telephone (NGT) | telephony providers. Examples are Level 3 and Qwest. |
| packetized voice or | One example of packetized voice is voice over internet |
| voice over a | protocol (VOIP). Voice over packet refers to the carrying of |
| backbone | telephony or voice traffic over a data network, e.g. voice |
| | over frame, voice over ATM, voice over Internet Protocol |
| | (IP), over virtual private networks (VPNs), voice over a |
| | backbone, etc. |
| Pipe or dedicated | A pipe or dedicated communications facility connects an |
| communications | ISP to the internet. |
| facility | |
| point of presence | A POP refers to the location within a LATA where the IXC |
| (POP) | and LEC facilities interface. |
| point-to-point | A virtual private networking protocol, point-to-point |
| tunneling protocol | tunneling protocol (PPTP), can be used to create a “tunnel” |
| (PPTP) | between a remote user and a data network. A tunnel permits |
| | a network administrator to extend a virtual private network |
| | (VPN) from a server (e.g., a Windows NT server) to a data |
| | network (e.g., the Internet). |
| point-to-point (PPP) | PPP is a protocol permitting a computer to establish a |
| protocol | connection with the Internet using a modem. PPP supports |
| | high-quality graphical front ends, like Netscape. |
| postal telephone | State regulated telephone companies, many of which are |
| telegraph (PTT) | being deregulated. NTT is an example. |
| private branch | A PBX is a private switch located on the premises of a user. |
| exchange (PBX) | The user is typically a private company which desires to |
| | provide switching locally. |
| private line with a | A private line is a direct channel specifically dedicated to a |
| dial tone | customer's use between two specified points. A private line |
| | with a dial tone can connect a PBX or an ISP's access |
| | concentrator to an end office (e.g. a channelized T1 or PRI). |
| | A private line can also be known as a leased line. |
| public switched | The PSTN is the worldwide switched voice network. |
| telephone network | |
| (PSTN) | |
| regional Bell | RBOCs are the Bell operating companies providing LEC |
| operating companies | services after being divested from AT&T. |
| (RBOCs) | |
| signaling system 7 | SS7 is a type of common channel interoffice signaling |
| (SS7) | (CCIS) used widely throughout the world. The SS7 |
| | network provides the signaling functions of indicating the |
| | arrival of calls, transmitting routing and destination signals, |
| | and monitoring line and circuit status. |
| switching hierarchy | An office class is a functional ranking of a telephone central |
| or office | office switch depending on transmission requirements and |
| | hierarchical |
| classification | relationship to other switching centers. Prior to AT&T's |
| | divestiture of the RBOCs, an office classification was the |
| | number assigned to offices according to their hierarchical |
| | function in the U.S. public switched network (PSTN). The |
| | following class numbers are used: class 1 = Regional |
| | Center(RC), class 2 = Sectional Center (SC), class 3 = |
| | Primary Center (PC), class 4 = Toll Center (TC) if operators |
| | are present or else Toll Point (TP), class 5 = End Office |
| | (EO) a local central office. Any one center handles traffic |
| | from one to two or more centers lower in the hierarchy. |
| | Since divestiture and with more intelligent software in |
| | switching offices, these designations have become less firm. |
| | The class 5 switch was the closest to the end subscriber. |
| | Technology has distributed technology closer to the end |
| | user, diffusing traditional definitions of network switching |
| | hierarchies and the class of switches. |
| telecommunications | A LEC, a CLEC, an IXC, an Enhanced Service Provider |
| carrier | (ESP), an intelligent peripheral (IP), an international/global |
| | point-of-presence (GPOP), i.e., any provider of |
| | telecommunications services. |
| transmission control | TCP is an end-to-end protocol that operates at the transport |
| protocol (TCP) | and sessions layers of OSI, providing delivery of data bytes |
| | between processes running in host computers via separation |
| | and sequencing of IP packets. |
| transmission control | TCP/IP is a protocol that provides communications between |
| protocol/internet | interconnected networks. The TCP/IP protocol is widely |
| protocol (TCP/IP) | used on the Internet, which is a network comprising several |
| | large networks connected by high-speed connections. |
| trunk | A trunk connects an access tandem (AT) to an end office (EO). |
| wide area network | A WAN is a data network that extends a LAN over the |
| (WAN) | circuits of a telecommunications carrier. The carrier is |
| | typically a common carrier. A bridging switch or a router is used |
| | to connect the LAN to the WAN. |

Further exemplary embodiments of the present invention are further described below by way of example only, and not limitation.

### Exemplary Use Cases

### Call Filter by Availability

According to an exemplary embodiment, the user may be provided the ability to change the user's availability using the PPD device 100 to change from, e.g., A9 to A0 which may mean to send all calls to Voice Mail (VM), for example. According to an exemplary embodiment, the feature may be also called “Instant Do Not Disturb (DND).” According to an exemplary embodiment, the user may take an important call on her desk phone and may want to shut down all other callers. The user may use the PPD 100 to dial A0. According to an exemplary embodiment, the user may be provided a preprogrammed instant DND button on the PPD 100 making this only one button to press. According to an exemplary embodiment, any other incoming calls may be sent to VM. According to an exemplary embodiment, the user may be provided with confirmation on the display of settings (A0). According to an exemplary embodiment, calls may be sent to one voice mail (may interface with existing VM).

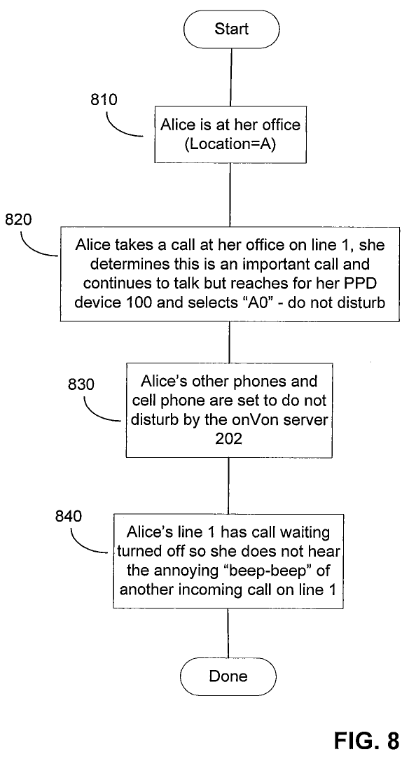

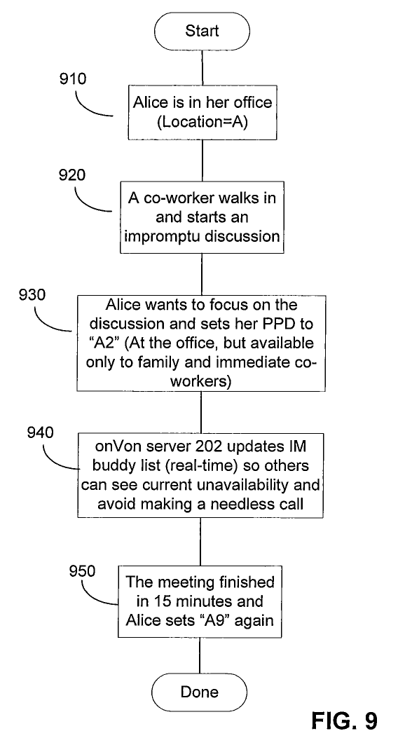

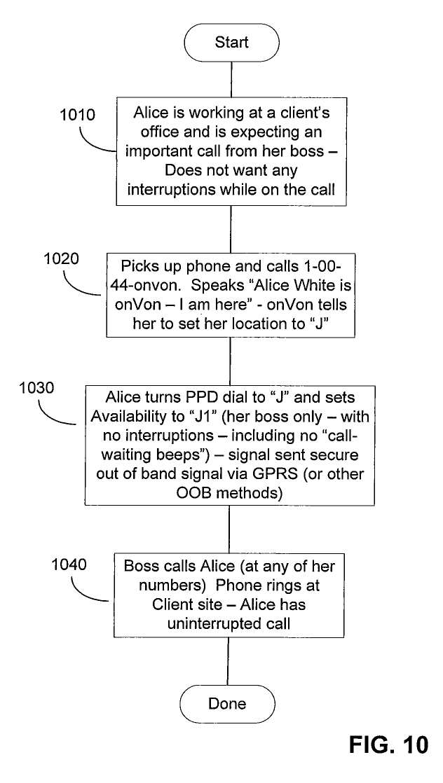

Exemplary use cases are presented in the process flow diagrams of FIGS. 8, 9 and 10. FIG. 8 presents a process flow diagram where Alice wishes to focus on one call. FIG. 9 presents a process flow diagram where Alice is in a meeting and wishes to limit communication access to important callers. FIG. 10 presents a process flow diagram where Alice is at a client office and wishes to limit access to her boss only, with no interruptions.

### Call Filters by Levels

According to an exemplary embodiment, the user may be in her office and a co-worker may stop by her desk to chat. According to an exemplary embodiment, the user may use her PPD 100 to change from A9 to A4. A9 may take all callers. A4 may take calls from only other co-workers, spouse, etc., according to an exemplary embodiment. Exemplary displays may include: Displays A9=Accept all Calls; Displays A4=Coworkers Only; and Rotary dial.

### Call Filter by Rules

The “Call Filter by Availability” and “Call Filter by Levels” use cases described above have fairly limited and strict levels of availability and access groups for each state. Though this might be desirable in certain cases, an alternative exemplary embodiment using rules and algorithms which weigh the value of the current activity against the incoming caller could also be used. As well, the rules filters could define meta groups such as “people I am meeting with today” or “people I have called recently”.

### Redefinition of Location

According to an exemplary embodiment, the user may be working at a client's site and may wish to redefine the user location. The user may dial 1-800-AGOVO and may identify the user by, e.g., but not limited to, touchtone password, etc., and may add the client's phone as a new location. For example, the feature in an exemplary embodiment, may not be available by voice recognition. In an exemplary embodiment, the feature may include a location J=212-555-1212. The user may say the call in number, use this or a new number. In an exemplary embodiment, the Now location J may be made available on the PPD device 100 to re-direct calls. According to an exemplary embodiment, the feature may provide redefinition of location. In an exemplary embodiment, this feature may be customized or initiated from a website.

### Call Redirect in a Call

According to an exemplary embodiment, the user may be at home and may take an incoming call on her cell phone from Bob. According to an exemplary embodiment, the user, two minutes into the call on her cell phone, may realize this will be a 45 minute call, she also may see her cell battery power is low. According to an exemplary embodiment, the user may tell Bob she wants to change handsets. According to an exemplary embodiment, the user may use the PPD 100 to signal to park her current call and may re-direct to her home phone. On the PPD 100 she may press MENU>REDIRECT>B. When moving location A>B, the user may be prompted to say “you have an open call, do you want to transfer this call?” The service provider may place her cell call on hold, her home phone may ring—Alice may be talking again to Bob.

### Click to Call (Dialer to a Buddy)

According to an exemplary embodiment, the user may use the PPD 100 to click to call Bob. According to an exemplary embodiment, the user may press MENU>CLICK-TO-CALL>DIRECTORY>BOB. According to an exemplary embodiment, the user may be prompted CALL FROM WHERE>A. According to an exemplary embodiment, the user's desk phone may ring, voice says “This is Agovo, standby for second call leg setup”. According to an exemplary embodiment, the Call handling presence server may call Bob, and may join the calls. According to an exemplary embodiment, the user may talk to Bob from her Office phone.

### Show Your Presence to Your Buddy List

In an exemplary embodiment, the user may allow certain users in her buddy list to see her availability on the service provider website. In an exemplary embodiment, the user may approve friends of the user may be allowed to login to the call handling presence server and display the user's presence.

### Voice Over IP Bridging

In an exemplary embodiment, the user may be at her desk, she may want to make a long distance call to a co-worker. The user may call the Call handling presence server and may say “Give me a VONAGE™ line for my outgoing calls”. The Call handling presence server may give the user her VoIP dialtone (or corporate dial-tone or other lowest cost network dial-tone). Combined Features may include: Click to call Bob from the Office (A) via VONAGE; MENU>CLICK-TO-CALL>DIRECTORY>BOB>VIA>VONAGE.

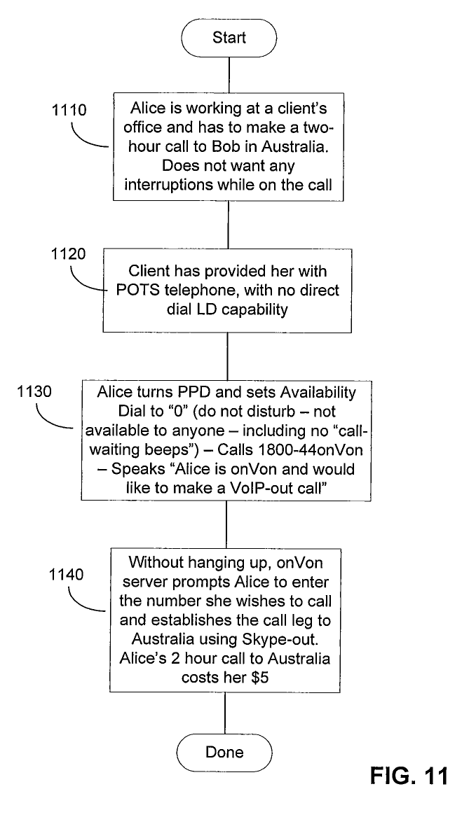

Alternatively, the user may be at a client office with access to a POTS telephone having no long distance (LD) capability. The call to Australia could be completed via Skype-out in the manner shown in the process flow diagram of FIG. 11.

### Outgoing Call Line Selection

In an exemplary embodiment, the user may be driving, she may want to make a long distance call to a co-worker in Australia. The user may use the PPD 100 to click . . . . Call TO, Call FROM, with Call VIA . . . . Summary: On the PPD . . . MENU>CLICK-TO-CALL>CALLFROM>Cell; CALLTO>DIRECTORY>BOB; CALL VIA>VONAGE. A call leg may be established to the user's cell. A call leg may be established to Bob via Vonage. The user may talk to Bob via Vonage (avoiding expensive mobile long distance rates).

### Rescue Call/Wake-Up-Notice Call

In an exemplary embodiment, the user may call the call handling presence server and may request an incoming ring and/or vibrate on the PPD 100. This feature can also be triggered via SMS, for example, but not limited to. The callback can be immediate or delayed. In an exemplary embodiment, the user may use this feature to end a meeting which is going too long: Alice may use the PPD 100 to press the preprogrammed instant button “RingMe my current location in 2 Minutes”. In an exemplary embodiment, the user may also use MENU>CALL-BACK>WHEN>0, 1, 2, 3 minutes>WHERE>A (cell, office, home). This feature may be used as a “Rescue Call” to end a meeting. In an exemplary embodiment, the call can be driven by a Calendar to Notify of a Schedule or Wake-Up Call. In an exemplary embodiment, the user may ring the PPD 100 to find his or her keys. In an exemplary embodiment, the user may redefine buttons as soft keys.

### Show Number of Pending Voice Messages

In an exemplary embodiment, the user may press the PPD 100 to show the number of voice mails pending. The PPD 100 may display who, what, when, etc. In an exemplary embodiment, the user may select message polling by pressing for a query, rather than constant updating.

### Break Thru Caller

In an exemplary embodiment, the user may be a PPD user, and Dave is the user's boss. Dave calls the user. In an exemplary embodiment, the user may define a break thru list the user may define with the web interface. In an exemplary embodiment, the user may create a PPD to PPD Instant Message. Alternatively, in an exemplary embodiment, the user may give important people the ability to enter, e.g., a touch tone code at the end of the user's phone number (e.g. 902-555-1234*123) to get through even though the called party might not be in your current availability group. As an example, the user's daughter may call the user from a phone without caller ID—the user would want her to get through to the user but the service has no way to know it's her—she can enter a code the user may have given her beforehand (e.g., during the call or possibly when she gets the user's voice mail) to let the system know the user wants the call to go through. Alternatively, in another embodiment of the invention, one could use voice recognition as a means of caller break through. This feature is an alternative to calling the person in the next cubicle and saying “Ask Alice to call me”.

### Presence Confirmation

According to an exemplary embodiment, presence may be confirmed to an Agovo device upon setting (Web/Phone or PPD). According to an exemplary embodiment, an indication of confirmation may include, e.g., but not be limited to, a vibration, a ring-tone, a flash of the light, etc.

### Voice Mail Greeting Change

According to an exemplary embodiment, the user may have the ability to pre-record multiple personal voice mail greetings. For example, but not limited to, the user may select “I just stepped out of office for 10 minutes,” “it's Monday blah blah blah”, “it's Tuesday blah blah—I'm unavailable—please call 555-1212 and Chuck will help you,” and/or a group of standard greetings that may come from which the call handling presence server users may choose.

In an exemplary embodiment, the user may quickly and easily change/toggle these messages using the menu key and dials on the PPD or phone/PDA software as needed. Alternatively, the system may select the appropriate greeting in accordance with the user's rules. That is, if the user has a meeting scheduled in his calendar and a call is allowed to go to voicemail, the call handling presence server will advise that the called party is in a meeting.

### Outlook—Calendar Management

According to an exemplary embodiment, a calendar may be automatically (or single-button press) uploaded to a call handling presence server 202. The call handling presence server 202 may send notifications and reminders to appointments (as desired). According to the exemplary embodiment, the user may initiate calls to conference call bridges as required.

### Call Handling Presence Server—Machine Learning

According to an exemplary embodiment, the call handling presence server may be provided machine learning based upon contact information and user call handling patterns (sending call to VM allowing caller through). According to an exemplary embodiment, additional call handling rules can be derived. According to the exemplary embodiment, rules can be forwarded to the PPD and/or a Web server to approve.

As noted above, the call handling presence server monitors user context such as presence, day, time, relationship to the caller, and the user's current activity. The state of these various conditions are plugged into the rules to determine how a certain incoming communication should be handled.

The process of developing new rules based on call management observations is straightforward for simple cases as there are a finite number of conditions to be monitored and a finite number of actions that can be taken. For example, it is straightforward for the call handling presence server 202 to identify which callers are important to the user by the fact that they very consistently pick up calls from that individual when he or she is identified in a call display. In contrast, low priority callers can be identified by the user consistently allowing those calls to go to voicemail. When such patterns are identified, the call handling presence server 202 can ask the user whether a new rule is to be generated.

While simple cases are effective and straightforward to implement, it becomes difficult to implement machine learning as the number of rules and context variables grows. Before proposing a rule, the system must identify the relevant context variables, and define acceptable bounds and conditions that apply. While this is a complex process, the system of the invention enables machine learning because it identifies and organizes context variables and allows them to be managed in a systematic way. Prior art systems cannot offer effective machine learning because they do not provide this functionality.

Thus, the process is generally as follows:

1. reviewing call records for the existence of patterns, such as:
a. the user consistently allowing call-displayed calls from a certain telephone number to go to voicemail (or rather than consistent, looking for a certain percentage of calls above a threshold level);
b. the user consistently deleting email messages from a certain address, without reading them (or again, rather than consistent, looking for a certain percentage above a threshold level); or
c. the user consistently performing a certain behaviour during a specific set of circumstances (i.e. in a specific context state);
   2. responding to such a pattern being detected by generating a new proposed rule consistent with the pattern detected (i.e. populating fields of a previously prepared rule proposal);
   3. transmitting the proposed new rule to the user and suggesting that it be adopted; and
   4. responding to the user authorizing the new rule, by updating the user's rules and preferences, otherwise simply dropping the proposal.

Of course the system may also look for other patterns. The system may also include other functionality, such as including a checkbox in the proposal message reading “never propose this rule again”.

### Video Service Control

The PPD 100 device, according to an exemplary embodiment, may be used as a remote programmer for a personal video recorder (PVR) or digital video recorder (DVR). For example, if a user is talking to a friend about a new show, the user could set it to be recorded on a DVR or PVR.

The PPD 100 device, according to another exemplary embodiment, may be used for re-broadcasting. According to an exemplary embodiment, a user is visiting a friend (or at work) or where the user has a browser, such as, e.g., an Internet browser, and no television (TV) and the user wants to access stored content, e.g., on a DVR or PVR (previously recorded, or on demand), remotely. Then, in an exemplary embodiment, the user may direct the user's DVR/PVR to stream the previously recorded (or on demand) content to a Web-Browser (e.g. the user may be traveling, but may want to watch the local news).

The PPD 100 device, according to yet another exemplary embodiment, may be used with an Interactive television (iTV) or receiver device. In an exemplary embodiment, the user may wish to purchase something shown in a commercial or in programming (e.g., the user may select a prompt to “send me info on a particular vehicle” such as, e.g., a pickup truck). Various conventionally known interactive television functionalities may be combined with the present invention to achieve further features of the present invention.

Regarding TV options, the PPD 100 may control the type/source of 2-way TV messages, according to an exemplary embodiment. In a 2-way Internet Protocol (IP) TV environment, a person can “click” to indicate “please send me more information on that Ford™ F-150™.” In an exemplary embodiment, the user may control who and/or when a third party can contact or send a message to the user.

In a converged TV and communications environment, according to an exemplary embodiment of the invention, a TV may accept a phone call, making the TV the recipient of a regular or video call to the telephone number of the user. The interactive television may include a display of caller ID information on the TV. In an exemplary embodiment, the PVR/DVR may automatically pause to give the user an opportunity to answer the call without missing programming.

According to an exemplary embodiment, the user may have the choice of accepting the call on the TV while pausing video programming (thus, the user can manage presence or the user's willingness to accept a call based on the importance of the programming—for example, never, ever interrupt the Superbowl!).

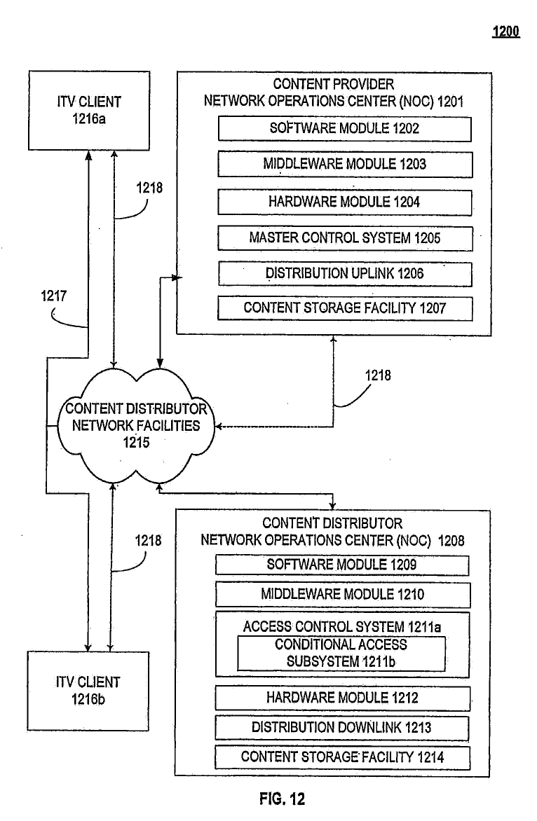

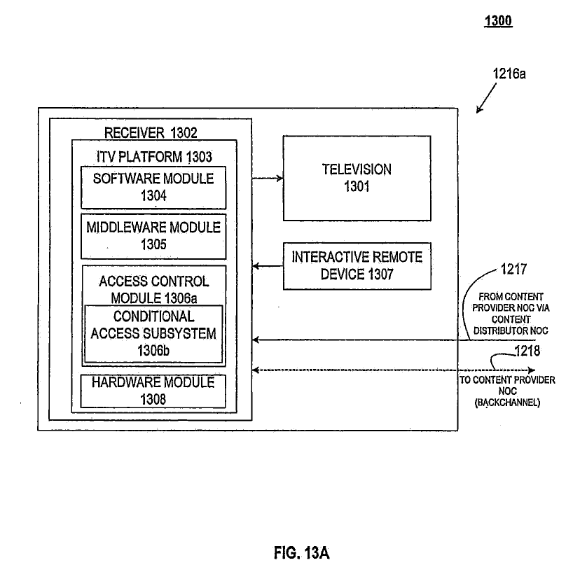

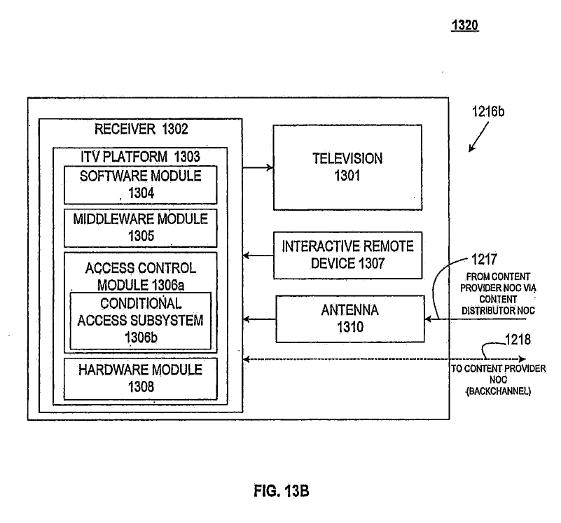

For further information regarding ITV, see the ITV overview below with reference to FIGS. 12 and 13.

Receiving phone calls on the TV, according to an exemplary embodiment may simply be an extension of the user's home number, or may be an alternate number (or IP address) to establish a video conference.

The PPD 100 device, according to an exemplary embodiment, may be used for Video Conferencing via television (TV) call control. Availability may vary based upon a user's watching habits.

The PPD 100 device, according to an exemplary embodiment, may be used for remote surveillance. In an exemplary embodiment, remote security watching may be enhanced with the PPD 100. In an exemplary embodiment, the user may have security cameras installed. For example, the user may be out for an evening, and a babysitter may be at home. The user may monitor the user's kids (and their caretaker) from wherever the user is (or even set up a stream to the user's video enabled phone). Similarly, in another exemplary embodiment, for day care providers, the user may also review/surveil using installed cameras.

### Interactive Television Overview

FIG. 12 presents an exemplary embodiment of the invention where the PPD 100 may be adapted to communicate with an interactive television (ITV) environment 1200 using signaling. The PPD 100 of an exemplary embodiment of the present invention, although described below in a particular environment, may be implemented, as previously noted, in a variety of other environments.

ITV environment 1200 in an exemplary embodiment may include a content provider network operation center (NOC) 1201, a plurality of ITV clients 1216a, 1216b, etc. and a content distributor NOC 1208. The content provider NOC 1201, ITV clients 1216a-b, and content distributor NOC 1208 may be coupled to one another by content distributor network facilities 1215 or other coupling device. The ITV environment 1200 of FIG. 12 also illustrates, in an exemplary embodiment, a distribution channel 1217 that may be used to broadcast content to the ITV clients 1216a, 1216b from the content providers over the content distributor network facilities 1215, and a backchannel 1218 that may be used to receive interactive responses from the ITV clients 1216a, 1216b at, e.g., the content provider. The back channel 1218 may be in an inband, or out-of-band channel. The back channel 1218 may be separate from the distribution channel 1217. The back channel 1218 may use circuit connections, or packet switched communication.

Content provider NOC 1201 may include, e.g., a software module 1202 and a middleware module 1203 running on top of a hardware module 1204. The hardware module 1204 may include, e.g., a processor and associated memory. The content provider NOC 1201 may also include a master control system 1205 that may be used to assemble portions of programming service content for distribution. The portions of programming service content may be accessed using various known methods from a content storage facility 1207, onto which the content may have been previously stored. The content provider NOC 1201 may also include a distribution uplink 1206 that may be used to upload content to the content distributor for distribution to ITV clients 1216a, 1216b, etc. Of course, the content provider in another exemplary embodiment, may communicate directly with ITV clients 1216a, 1216b. For example, the clients 1216a, 1216b, etc. may communicate via a communications link directly to the content provider via a protocol such as, e.g., but not limited to, simple mail transport protocol (SMTP), hyper text markup protocol (HTTP), simple message system (SMS), Internet relay chat, etc.

Content distributor NOC 1208 may include a software module 1209, a middleware module 1210, and an access control system 1211a including, e.g., a conditional access subsystem 1211b, running on a hardware module 1212. A distribution downlink 1213 can be used, in an exemplary embodiment, to download content from the content providers to the content distributor NOC 1208, for temporary storage in content storage facility 1214, prior to distribution directly to, or via the content distributor network 1215, to ITV clients 1216a, 1216b for viewing by viewers.

As shown in the exemplary block diagram 1300 in FIG. 13A, ITV client 1216a may include, in an exemplary embodiment, a television 1301, a receiver 1302, and an interactive remote device 1307 such as a remote control. Receiver 1302 can include, in an exemplary embodiment, ITV platform 1303 that can include, e.g., a software module 1304, a middleware module 1305, an access control module 1306a including, e.g., a conditional access subsystem 1306b (such as a smart card), and hardware module 1308. The hardware module 1308 may include a processor and associated memory. The various modules may be combined into a set-top box. The set-top box may be configured to record programming services. As shown in FIG. 13A, receiver 1302 can be configured to receive content from content provider NOC 1201 via, e.g., a content distributor network 1215 and content distributor NOC 1208, or directly via interface equipment, for example. The ITV platform 1303 of FIG. 13A can be thought of as an example environment that could be used for a content distributor that uses a cable television (CATV) network. Content may be distributed to ITV 1216a, 1216b, etc. from the content provider over content distributor facilities as shown in line 1217. Dotted line 1218 may represent an exemplary back channel 1218 for sending interactive information to the content provider. The back channel is typically provided via a phone modem or via access to a broadband network.

Alternatively, as is shown in the exemplary embodiment of block diagram 1320, in FIG. 13B, receiver 1302 can be configured to receive content from content provider NOC 1201 via content distributor network 1215 and content distributor NOC 1208 via antenna 1310, such as a satellite dish or the like.

The interactive television system described herein is exemplary only, and non-limiting. The invention can also be implemented in many other types of interactive systems. For example, the content provider may communicate directly with the ITV clients 1216a. Programming services, video and interactive television content may be provided directly to the viewer. Also, a back channel may be provided directly from the ITV client 1216a to the content provider, without passing through a content distributor. A back channel is not necessary in all embodiments of the invention.

As will be understood by a person having ordinary skill in the art, content provider NOC 1201 can distribute content via distribution uplink 1206 to content distributor NOC 1208. Content distributor NOC 1208 can receive the content from content provider NOC 1201 via distribution downlink 1213. Content distributor NOC 1208 can then distribute content to ITV clients 1216a, 1216b through content distributor network facilities 1215. Examples of content distributors include, e.g., COMCAST CORPORATION of Philadelphia, Pa., USA, DIRECTV of El Segundo, Calif. USA, ECHOSTAR COMMUNICATIONS CORPORATION of Englewood, Colo., USA, and TIME WARNER CABLE of Stamford, Conn. USA. Conventionally, content may be distributed over various network platform types including voice, data, cable television (CATV), wireless communications networks, direct broadcast satellite television, multichannel multipoint distribution service (MMDS) and wireless fidelity (WI-FI).

The content provided to the ITV clients 1216A may include a number of channels, such as broadcast network channels, cable channels, subscription channels, etc. These types of channels may be referred to as linear channels. Other types of programming services may also be provided, such as, e.g., on demand services. Exemplary forms of on demand services include, e.g., but are not limited to, a video on demand (VOD) service, a subscription VOD (SVOD) service, etc. Other on demand services may include any of various digital video recorder (DVR) offerings by which a viewer can record and view digital video content. An exemplary programming service program may include, e.g., a movie, or a series, that may be made available by a programming service such as, e.g., CBS, ABC, NBC broadcasting programming services, or pay services like SHOWTIME or HBO. Programs may also include, e.g., high definition (HD) programs, VOD and SVOD programs, and programs stored on DVRs. Viewers that have advanced set top boxes may be able to access robust digital video recording and playback capabilities.

### Conference Call Set-Up

The PPD 100 device, according to another exemplary embodiment, may be used to eliminate the need for explicit inbound conference call bridges. According to an exemplary embodiment, the user could see if others were not busy, and then using one number (or a Global Unique Identifier (GUID)) could reach the others, the Agovo service provider according to the present invention, may control all the access to the user, (where the user is, and at which number).

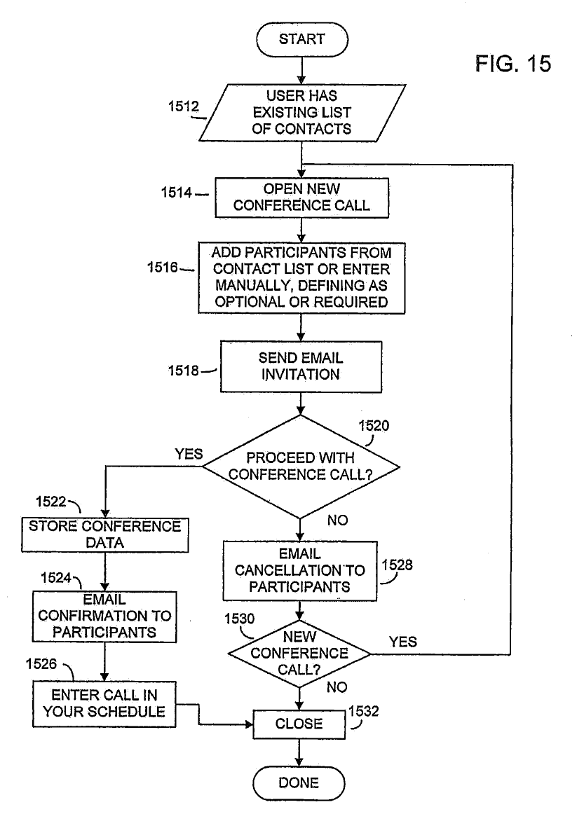

An alternative method of setting up a conference communication using a PPD or similar device is presented in the flow chart of FIG. 15. The bulk of the description is framed in terms of a telephone conference call being set up using a telephony system, but of course, could be applied to any manner of media, such as voice, text, video or combinations of these. As well, the conference communication could be set up over any communication network, and is not limited to the ones described herein.

In this embodiment, the system is preferably linked to a personal information manager (PIM) server supporting software such as Microsoft Outlook™, Groupwise™, or a similar application. The organizer of the conference call will typically have an existing list of contacts or addresses that they have been compiling over time 1512. To open a new conference communication 1514 the organizer simply clicks on a new menu option in his PIM software which opens a conference call window in the same manner that a new meeting or new appointment window would be opened. Alternatively, the system could simply generate a new appointment which can be defined as a conference communication (i.e. simply adding a new box to click, in the appointment setup window). The specifics of how this would be done depends on the particular PIM application being used.

From this “new conference” window, the organizer can specify the title or purpose of the conference communication, the time and date, identify his unique resource identifier (which is the conference call number), and any other particulars that he wishes to communicate to the participants. Note that the unique resource identifier may be a telephone number, email address, URL, or similar address (these may also change over time as technology evolves).

The system may also retrieve contact and calendar information from personal information management servers such as Outlook Exchange™. For example, the organizer may populate the list of participants for the meeting 1516 by dragging them from his contact list, or double-clicking on them. The organizer may also manually enter new participants into this list, though that would require both the new participant's email address and telephone number (or numbers) that they would be expected to call from. As well, the organizer may be able to access the personal schedules of certain participants so he can propose a time at which participants are available. If the first attempt to set up a conference fails, then the originator is in a far better position to make a second attempt than he would be with a prior art system.

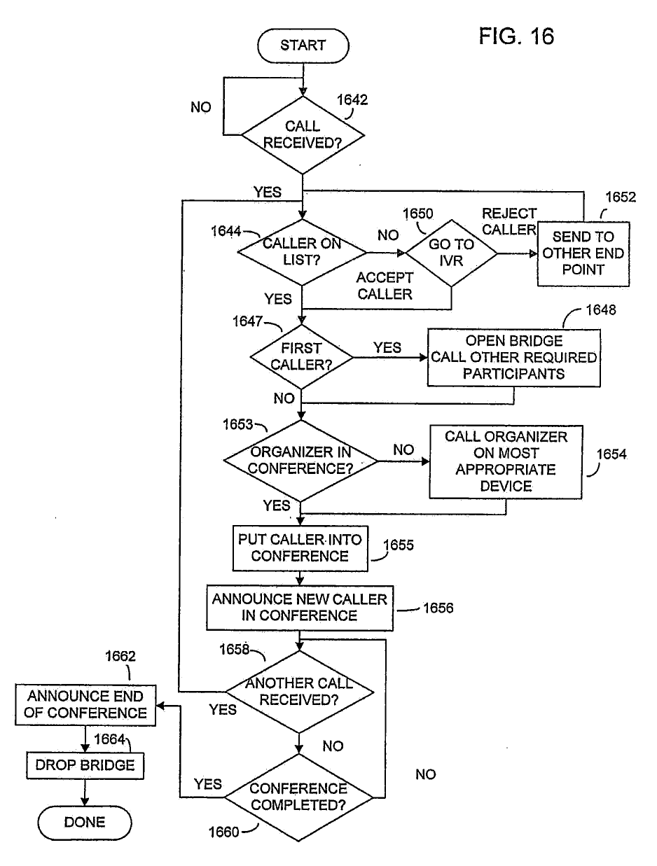

The organizer may also be able to specify whether participants are to be considered “required” or “optional” as part of step 1516. As shown in FIG. 16, the system may automatically endeavour to seek out the “required” participants once the communication has commenced, and will not seek out the “optional” participants. Of course, if the “optional” participants attempt to join the conference, they may be allowed to do so.

In an embodiment of the invention the system may dynamically assign a conference bridge to any telephone number on the local system, on demand. The conference server (possibly on a PBX, IP PBX, or similar system) may have a pool of common conference rooms that can be assigned to a given phone number when the relevance engine server specifies that it is required. It is safe to assume that not every telephone number on the local system is going to require a conference room at the same time, thus the size of the pool of conference rooms does not need to be the same as the number of telephone numbers that exist in the system. The size of the conference room pool should be chosen to minimize the use of resources while at the same time ensuring that the probability of running out of conference rooms is sufficiently low, and will depend, of course, on the nature of the business environment. Resource management of this kind is well known in the field of telephony systems.

Once the particulars of the proposed conference communication are established, the participants are then emailed an invitation to attend at step 1518. The organizer waits for responses from the participants and decides whether to proceed with the call 1520 based on the responses that he receives. If the organizer decides to proceed with the call, then the relevance server stores the particulars 1522 of the conference call, that is, participant information, time and date, originator's telephone number, and any other related data. It then may send a confirmatory email to all of the participants 1524, and enter the call into the organizer's schedule in his PIM application 1526.

If the organizer decides not to proceed at step 1520, then an email cancellation will be sent to the participants at step 1528. The organizer will then have the option of proposing a new conference call at step 1530. If he decides not to proceed, then the application closes at step 1532, otherwise, control returns to step 1514 so that a new conference communication can be proposed.

This system provides for a much more efficient method of setting up conference calls than known systems and methods. Prior art systems typically require more steps as the organizer must interact separately with the provider of the conference bridge. With the system of FIG. 15, the conference bridge is tightly tied to the system, so the organizer does not have to interact with it at all, much less having to interact with a third party. As well, the organizer is able to leverage off of his existing PIM software in many ways, including: setting up the proposed conference call as easily as setting up any meeting or appointment, selecting participants from his contact list, investigating the availability of participants from their personal schedules, automatically having emails generated and automatically having the confirmed conference entered into his schedule. This makes for a very user-friendly system as users who are familiar with their PIM software have almost nothing more to learn.

FIG. 16 presents a flow chart of a complementary method of initiating and holding a conference communication in an exemplary embodiment of the invention. This method could be performed completely independently of the setup method, though it is preferred that both be performed as part of the same system.

Participants simply call the conference organizer's normal telephone number (or contact him via any other unique resource identifier) and they may automatically be placed in the conference because they appear on the list of conference participants. The first participant to call the organizer, during the specified time of the conference, may cause the conference bridge to be setup and all of the required participants to be contacted and joined into the conference bridge. The participants do not need to remember or record a bridge telephone number, conference number, pin code or any other information that is particular to the conference communication. If a caller is not listed as a participant in the conference call they are routed elsewhere, for example, to voicemail, or to a delegate such as a receptionist or assistant to the originator of the conference. If the caller is very important to the organizer but is not a conference call participant, the caller could be rerouted to the organizer's communications device but not into the conference bridge. FIG. 16 outlines this process in greater detail.

The process begins with the arrival of a call on the organizer's normal telephone number at step 1642. This waiting step 1642 is shown as a loop in this figure, but this is in the interest of simplicity only. Different telephone, PBX, IP-PBX and Internet Telephony systems will detect the arrival of incoming calls in different ways, using polling, interrupts, and the like.

When a call arrives at step 1642, the organizer's relevance engine notes that a conference call is scheduled and determines whether the calling party is on the participant list for the conference, at step 1644. Additional information on the development of the relevance engine appears in the co-pending U.S. patent application Ser. No. 11/382,130 titled “Method of and System for Telecommunication Management”, the contents of which are incorporated herein by reference. In the case of step 1642, the relevance engine's task is quite simple—monitoring the organizer's PIM so it knows that the organizer has set up a conference call, and considering whether calling parties should be allowed to join that conference call.

Of course, the conference communication organizer could also initiate the conference himself by calling his own telephone number. If the organizer calls his own telephone number from any of his devices (cellular telephone, desk telephone, or personal digital assistant, for example), the system will recognize that he should be in the conference and call all of the “required” participants. The organizer may also initiate a conference from a personal computer or personal digital assistant that uses web services to communicate with the server supporting the system, and call all of the “required” participants including himself.

In the general case, the relevance engine considers how to handle communications based on the user's current “context”, and a set of rules that the user has established. The relevance engine may be set up, for example, to determine the current physical location of a particular participant by monitoring usage of their desk top computer, cellular telephone or home telephone, and making an attempt to locate the participant at a corresponding telephony device. If the participant is using his desktop top computer to send emails, for example, the relevance engine will expect that the participant can be reached at his desk top telephone. The relevance engine may also have specific rules established which prevent unimportant telephone calls from going to the participant immediately prior to a conference call. Some of the context parameters that the relevance engine might consider are listed hereinabove.

The task of determining whether the caller is on the participant list for the conference, at step 1644, may be done by determining the caller ID/SIP unique resource identifier, and checking to see whether this calling telephone number matches a participant's telephone number in the conference data file. Caller ID is well known functionality that is available on both the PSTN and most Internet-based telephony systems. Of course, caller identification may also be done in different ways, appropriate to the communication system being used.

The conference data file will typically have more than one telephone number for each participant, including for example, their office, home and mobile telephone numbers. Thus, the participant may call from any one of these locations and a match will still be found so they can join the conference.

If the calling party is not on the participant list or is on the list but is calling from a telephone number that is not on the list, then control may pass to step 1650 where an interactive voice response (IVR) system challenges the caller for information that might allow them to access the conference bridge. For example, the PBX/Phone switch's IVR could answer the call and direct the calling party to enter the telephone number that they usually call from. This new telephone number could then be compared against the conference communication data file.

This could happen at the beginning of the call, or once the caller had been sent to voicemail. So if someone that is supposed to be in the conference call ends up in voicemail, the phone switch would ask the user to type in their usual phone number and then the switch would query conference call data file again and the caller would be connected to the conference communication bridge.

If it is determined that the calling party should not be allowed to join the conference communication at step 1650, the calling party may be rejected and sent to another endpoint at step 1652, for example going to voicemail. The originator's relevance engine could be used here to determine the correct device that the call should be routed to, such as his user's device, voicemail, decline or a redirected to a delegate.

If it is determined that the calling party should be allowed into the conference communication at step 1644, then the system determines whether the calling party that has just been accepted, is the first caller into the conference communication at step 1647. If so, then the system may open a conference bridge, and generate a “call out” list to call all of the remaining required participants at step 1648, along with the organizer, using the IVR to remind them of the scheduled conference call. The system will preferably call these parties on their most appropriate communication device, so they are joined into the call as quickly as possible. This minimizes the time that the first participant will remain alone on the conference call, and also minimizes the delay while waiting for other participants to join.

It is then determined at step 1653 whether the organizer has joined the conference call. If not, then the system will attempt to locate the organizer at step 1654, on his most appropriate device. The identification of the organizer's “most appropriate communication device” can be done using the context engine as described in the co-pending U.S. patent application Ser. No. 11/382,130, the contents of which are incorporated herein by reference. As noted above, the context engine will seek out the best way to contact the organizer based on his current “context”, for example, monitoring the usage of his desk top computer, cellular telephone or home telephone, and making an attempt to locate the participant at a corresponding telephony device.

The caller is then connected to the conference bridge at step 1655, and an announcement of the new participant's arrival is made at step 1656.

The system may then wait for additional calls to arrive at step 1658. If a new call is received, control loops back to step 1644 for processing. Otherwise, processing loops through query 1660 where the termination of the conference communication is considered. If the conference is to continue, then control passes back to step 1658 to check for more calls. If the conference is to be terminated, then an announcement to that effect is made to step 1662 and the conference bridge is dropped at step 1664. Conference communications may terminate by timing out, or having all participants drop the conference.

This initiation process for conference communications offers many advantages over the known systems, in particular, in reducing the number of steps, improving the reliability of reaching all of the participants, and increasing the likelihood that the participants will successfully be able to join the conference.

### To-Call List

The PPD and associated system described herein may also be used to support a “to-call list” as described in the co-pending U.S. patent application Ser. No. 11/531,072, entitled “Method Of And System For Managing Outgoing Telephone Calls” the contents of which are incorporated herein by reference.

In an embodiment of the invention, this system allows the generation and maintenance of an electronic list of telephone calls that are to be made by a given user. It is like a to-do list, except that the actions are calls to specific individuals. The calling list may be populated from the user's address book and/or directory, as well as automatically from voicemail messages or email messages that are received. The calling list is designed to help users better prioritize calls which they wish to make in any given day, the telephone calls being sorted and listed by priority. The ordering of the calls in the list may change with respect to the availability of the parties and changing events. All the user must do to place a call is click on the “next” icon, and the system will locate the next highest priority call on the list and dial the telephone number associated with it.

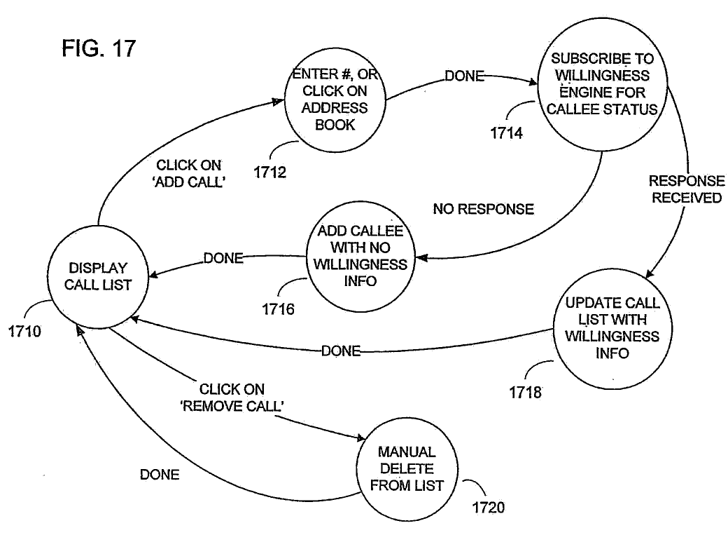

FIG. 17 presents a state diagram of an exemplary method of manually editing such a call list, by adding or removing call entries. The default state for the client software is to display the call list 1710 on whatever device the user is employing. The call list may be physically resident on the device, or be remote, supported for example, by an ASP (application services provider) system. In such an environment the user could access his list with any Web browser-enabled device, from any location that has access to the ASP.

When the user clicks on an “add call” tab or menu option, he may then add a new telephone number and textual identifier (i.e. the name of the party to call, or “callee”) to the call list 1712 by:

1) manually typing in the information;
2) clicking on an entry in his address book such as a Microsoft Outlook™ or Groupwise™ address book;
3) dragging and dropping the data from an email message, Web page or other source;
4) cutting and pasting this information into the call list;
5) dragging a contact from the directory, or address book, onto the call list;
6) right clicking on a contact, and choosing “Call Today”, or some other appropriate flag; or
7) dragging a contact and dropping it on a specific calendar entry.
As noted herein below, other online address books could be used, or even an address book that is custom to the software of the invention.

As part of the process of entering a new call, a new entry may be flagged as “Call Today”, “Call Tomorrow”, “Call Next Week”, or “custom”, that is, to call at a specific time and date. If multiple address book or directory entries are selected, and added to the To-Call list, they may also be flagged as “Conference Today”, “Conference Tomorrow”, and so on.

Once this has been done, the client software may then subscribe to the willingness engine for the new callee 1714 to determine the status for the new callee which has just been identified. A description of a “willingness engine” or “relevance engine” appears in the co-pending U.S. patent application Ser. No. 11/382,130 titled “Method of and System for Presence Management in Telecommunications”, and is incorporated herein by reference. In the case of state 1714, the relevance engine's task is simply to advise when the callee will be available to accept a call.

In the general case, the relevance engine may consider how to handle communications based on the user's current context as described herein above, and a set of rules that the user has established. The relevance engine may be set up, for example, to determine the current physical location of a particular participant by monitoring usage of their desk top computer, cellular telephone or home telephone, and making an attempt to locate the participant at a corresponding telephony device. If the callee is using his desktop computer to send emails, for example, the relevance engine will expect that the participant can be reached at his desk top telephone. The relevance engine may also have specific rules established which prevent unimportant telephone calls from going to the callee immediately prior to a conference call (for example), or conversely, send unimportant calls to voicemail while the user is in a meeting with his boss.

If the client software issues a request for willingness status to a callee and no response is received, then the callee is simply added to the calling list without any willingness information 1716. Processing then returns to the home state of displaying a call list 1710.

If the callee does not have software that supports willingness notification, then IM presence (Instant Messaging presence), could serve as a substitute. Of course, IM presence will only indicate availability, in contrast to actual interest in entering into the call. That is, if an IM presence server (IM presence servers being common in IM systems) indicates that the callee is online, then it can be assumed that the callee is at his personal computer and is able to accept calls at that location. If IM presence is not available, then an email may be automatically sent to the callee indicating that a particular individual would like to reach them, displaying times when the caller is willing to communicate, and inviting them to identify a time at which to call.

If the callee does have a willingness engine associated with him, then a willingness response will be received and the call list will be updated with the willingness information at 1718. The system then returns to the home state of displaying the call list 1710.

By determining whether the callee is physically available to his telephony device, and/or is willing to accept the call, the user has a much higher chance of placing a call successfully. Thus, the user can avoid leaving messages on voicemails.

Also from the home state of displaying the call list 1710, the user may click on a “remove call” tab or menu selection, which will manually delete the identified call entry from the calling list at state 1720. The system then returns to the home state of displaying the call list 1710.

Other processes of managing a “to-call list” are described in the co-pending applications referred to above.

### Watcher

As noted above, user context is very important to management of communications, and presence is an important part of that context. In implementing a “to-call list”, for example, it would be desirable to know whether the parties at the top of the list are available to receive calls. Hence, it is desirable to user “watcher” technology to determine the availability of other parties. It is also desirable to make your presence available to other parties.

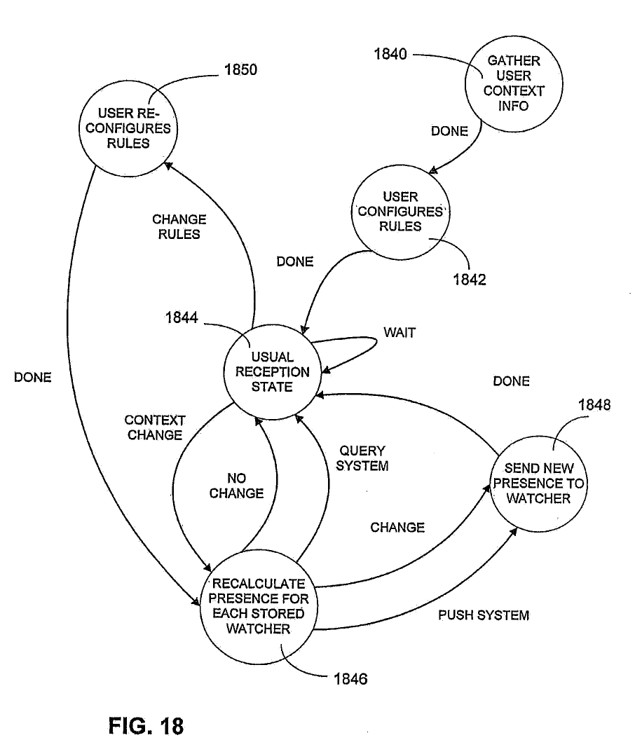

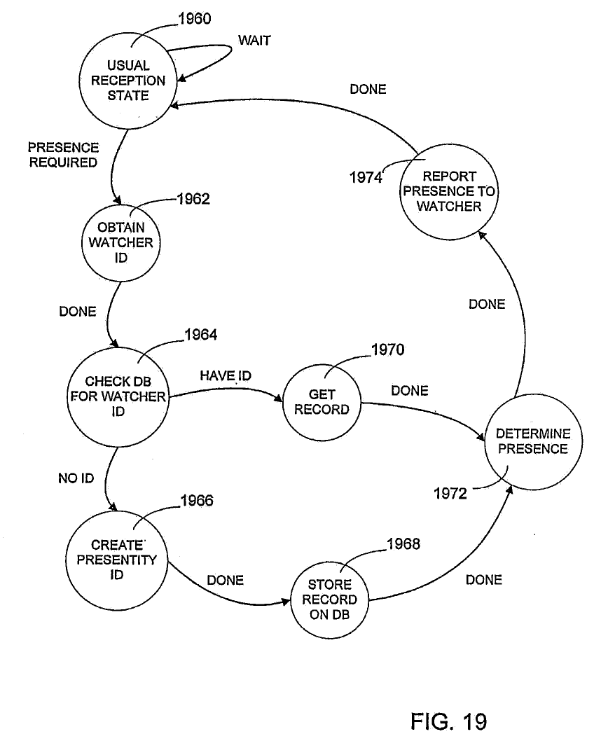

An exemplary implementation of such a system that can be integrated with the system described herein, is presented in the co-pending U.S. patent application Ser. No. 11/382,130, the contents of which are incorporated herein by reference. FIGS. 18 and 19 also present an exemplary implementation of such a system, FIG. 18 presenting the client-side maintenance of the rules and context information and FIG. 19 presenting the processing that occurs in response to a presence query.

The process begins with the gathering of user context information at state 1840 of FIG. 18. This context information may be collected both automatically and manually. For example, the user may be able to manually click on a box in a graphic user interface (GUI) which reads “do not disturb”, while he is having lunch or is participating in an ad hoc meeting with his boss. He may also click on various manual overrides such as: available, busy, busy but interruptible, do not disturb, out of the office, or on vacation.

As well, context information may be collected automatically from various sources such as:

meetings recorded in Microsoft™ Outlook™;

checking the time of day either online or on a local clock;

determining the user's physical location;

collecting presence status from other services; or

accessing stored lists of acceptable Watchers in user's groups.

Typically, the information will be collected using add-ons, software modules which are added to existing applications to provide access to the data that they require. Microsoft™ Exchange™, Yahoo™ Messenger, MSN™ Messenger and MS™ Outlook™ are all current applications from which contextual data may be obtained.

Contextual data could any piece of information that affects the willingness of a user to communicate with a watcher. Some examples are the on/off hook of various communication devices, GPS location information and ambient noise and environmental information.

Next, at state 1842, the User configures his rules, behaviours, and policies for assessing any incoming inquiries. Any number and variety of rules may be established to configure the system, and of course, the rules will vary with the nature of the communication medium. An exemplary set of rules is as follows:

For VIPs, I am always available.

During work hours, I am available for co-workers.

During work hours, I am busy for Friends and Family.

Outside of work hours, I am available for Family.

My wife, always has full access.

During Work Hours, Co-workers have full access.

Outside of work hours, Family has full access.

Authorized contacts have limited access.

Unauthorized contacts have no access.

It is preferable that the system architecture be designed to accommodate both beginners and experienced programmers. For example, the invention will be implemented with a software wizard which steps the user through the available options and has help support. At the same time, more experienced programmers will have the option of generating their own rules, using a scripting language or some similar tool.

The rules in the wizard will generally be established to reflect the most common scenarios and devices. Wizards dedicated to particular industries, professions and hardware systems can be generated and provided with the system. For example, if the user only has connectivity to two or three specific communication systems, it is not logical to present a long list of rules to them regarding other communication systems.

Once the initial context information has been collected at state 1840, and the rules established at state 1842, the process will sit in a wait state or “general reception state” 1844. From the wait state 1844, if a change occurs to the user's context, process control passes to state 1846 where the presence for each stored Watcher is recalculated in view of the new user context data. A presence record may be stored for each Watcher, so that it can be updated if there is a change to the user's context or his rules. The analysis and calculation of the presence state that should be reported to a given Watcher could be performed in several different ways (such as heuristics, artificial intelligence, neural networks, Bayesian networks, fuzzy logic, etc.), but it is preferable to use an “expert system” model as known in the art. In a “push” system—that is, a system in which presence is proactively forwarded to a service provider or Watcher so that the user's state can be published—the new state is broadcast at state 1848. If the system is either a query-handling system in which the system simply responds to queries regarding status, or there is no change to the state of the User's presence, then control simply passes back to the wait state 1844.

Note that it would only be desirable to issue new presence broadcasts where the presence has actually changed, to save on network resources. To do this, it is necessary that the last reported presence report be stored with respect to each Watcher so that a comparison can be made. A data record indexed by a unique Watch ID may be stored for each Watcher to facilitate this.

From the wait state 1844, the User may also request that his rules/behaviours/actions/policies/preferences (whichever language is appropriate to the type of analysis being used) be changed. In such a case, control passes to state 1850, where the rules wizard is launched again, but as a default, the fields of the wizard are populated as per the User's original data. The User is able to make whatever changes he requires and store the new set of rules. Control passes again to step 1846, so that the stored Watcher presence information can be recalculated.

Referring to FIG. 19, the transmission process will default to a wait state or “reception state” 1960. When a Watcher wants to see a User's presence, their client will ask the presence server for a “Presentity ID” based on the User's identifier such as a telephone number, cell number, email address, or other similar personal data appropriate to the nature of the communication presence being requested.

The presence server will then obtain the Watcher's identity at state 1962 and check to see whether a data record had been stored in the past which corresponds to this Watcher (or more accurately, to the Watcher's ID), at state 1964. If no record had been generated in the past, the presence server will create a Presentity identifier at state 1966 which is unique to this Watcher, by relying on or incorporating some attribute of the Watcher's ID. This Presentity identifier is then stored on the database at state 1968. Each User will have a Presentity ID for each Watcher. In systems where presence is cached outside the presence server the Presentity ID per watcher will allow these systems to continue to work normally.

If it was determined at state 1964 that the Watcher already had a data record on the database, then that record is simply obtained at state 1970.

In either case, process control now arrives at state 1972, where an analysis is performed based on the User's stored rules and context data, to determine what presence status should be reported back to the given Watcher. This analysis will include determining the authentication level of the Watcher's ID, to determine what ‘view’ of the user's presence the Watcher may see. At a simple level the authentication level may be one of: authenticated, unauthenticated or anonymous. Similar to state 1846 above, the analysis at state 1972 will preferably be performed using an expert system model but could be performed using other models.

The presence report is then sent to the Watcher at state 1974, and control returns to the wait state 1960.

### Music

The PPD 100 device, according to another exemplary embodiment, may be used to acquire play lists from, e.g., but not limited to, radio stations (in exchange for a portion of the revenues) and then if a user sends a request (such as, e.g., to buy/bookmark this song) to the server, the user may enter the station the user is listening to, and based on a timestamp would know by comparing the timestamp of station to what was being played, and could determine what was being played at that time. The music server according to an exemplary embodiment of the present invention, could send an email, or store on a website information to allow a later purchase.

The PPD 100 device, according to another exemplary embodiment, may be used for streaming. If the user had a computer loaded with digital content files, such as, e.g., but not limited to, Mp3s (and the computer is set up with software according to an exemplary embodiment of the present invention, (at the user's home)), a service provider, according to an exemplary embodiment could stream songs to the user's computer at work (for playing) and/or to a web device (similar to TV or DVD videos, discussed above). The service provider, in an exemplary embodiment, may merely send a streaming control signal to the computer to cause streaming to start.

The PPD 100 device, according to another exemplary embodiment, may be used for providing ambient music. According to an exemplary embodiment, if the user has a media center type computer (e.g., a computer equipped with audio and/or video capture and output capabilities) (an exemplary embodiment may include a device from Streetfire Sound Labs, of 340 Brannan Street, Suite 300, San Francisco, Calif. 94107) or SONOS Incorporated, of 223 E.De La Guerra Street, Santa Barbara, Calif., 93101. The device may be an embedded Linux box hooked up to 2 jukeboxes with 700 CD slots. The user can control where the music goes, what play lists play, etc. Thus, ambient music may be played and controlled by PPD 100.

The PPD 100 device, according to another exemplary embodiment, may be used to control satellite music. In an exemplary embodiment, the present invention may pull down play lists, and may use the PPD 100 device to, e.g., but not limited to, set channels, figure out what was played that the user liked, etc.

### Ambient Devices

The PPD 100 device, according to another exemplary embodiment, may be used to control information flows via, e.g., but not limited to, a separate datacast network to, e.g., but not limited to, a user's ambient display devices in the room. If the user has display devices receiving data via, e.g., but not limited to, a data casting network (an exemplary embodiment may include a device from Ambient Devices of One Broadway, 14^{th} Floor, Kendall Square, Cambridge, Mass. 02142), then the device may change information to be displayed and/or cause different information to be appear on the user's display (i.e. ambient) device via the PPD 100 device.

In another exemplary embodiment call creation may include, e.g., but not limited to, auto selection of parties and the way to connect (via VoIP) so the user may press “go” and everything will be set up automatically.

Previous references to ONVON and GIZVO have been revised to reflect AGOVO and KeyFob or PPD. The PPD is a handheld device such as, e.g., a fob to which keys may be attached. The device may be approximately 2 inches to 2.5 inches in length.

### Remote (Home Entertainment)

The PPD 100 device, according to another exemplary embodiment, may be used as a universal remote control. Software is available today to modify a PDA to act as a universal remote. According to an exemplary embodiment, the PPD 100 device may be used to obtain meta data about TV shows, the CDs in a player (or jukebox) etc.

### Home Automation

The PPD 100 device, according to another exemplary embodiment, may be used in junction with home automation control systems as a remote control. There are various home automation control systems (based upon the well known ×10 standard) that may be remotely controlled. Thus, the PPD 100 may be used to send a message (e.g., “I am coming home early today, please warm up the house”, or “Honey—The Iron and Stove are OFF”).

### Home Telephony

The PPD 100 device, according to another exemplary embodiment, may be used to control home telephones (much the way a home private branch exchange (PBX) may do so) via the PPD 100 device. The PPD 100 device may enable, e.g., but not limited to, call routing, call handling, parking etc. all on either one twisted pair and/or on two twisted pair. According to an exemplary embodiment, there may be a small box attached to each phone (which may look like a DSL line filter) that may be controlled by the PPD 100, also known as the AGOVO PPD or a home AgoVo telephony device according to exemplary embodiments of the present invention. A call may come in, that the user could have set up (via, e.g., the web), and the call may go to the phone at which you are located (and only that phone may ring). According to an exemplary embodiment, the system may include a way to identify the user location. In an exemplary embodiment, any of various well known methods to determine a user location may be used. For example, in an exemplary embodiment, the location of the user may be determined by, e.g., but not limited to, use of a radio frequency identification tag (RFID). The user's location may alternatively be determined, by user keying, or entry on the PPD 100. According to an exemplary embodiment, by adding an exemplary device to a phone line, then a plain old telephone system (POTS) phone may become the equivalent of a PBX. The cost of the exemplary embodiment would be more like a few hundreds, instead of $1,000+ or more to have a PBX installed.

### Remote PC

The PPD 100 device, according to another exemplary embodiment, may be used to access a device over the Internet. According to an exemplary embodiment, a file/email from a home PC may be obtained, and the user may be sent an email/or the system may try to sent it to another location.

### Security and Triple-A (Authorizing, Authentication and Audit/Accounting)-Radius

The PPD 100 device, according to another exemplary embodiment, may be used along with a RSA device, or other security device, like a Radius server. Other authentications could be handled by the PPD 100 including, e.g., but not limited to, an identifier (e.g. fingerprint/Iris scans, biometrics, etc.) and what the user knows (e.g., may require entry of a password and/or other input). Also, in an exemplary embodiment, the system may identify where the user is (which may be done with location information from the carrier). The system may identify what you have done (i.e. are you following normal patterns of behaviour, or psychographic (or behavioural) demographics). The PPD 100 may be used to provide an authentication signal when, e.g., a user is prompted to provide further authorization for a large credit card purchase. The PPD 100 device may provide extensive additional information. For example, a thumb scanner on the PPD 100 device may be very small. A thumb scanner, or other biometric may be used to create a secure environment. Strong encryption is particularly useful in controlling access to corporate networks.

### Location Access

The PPD 100 device, according to another exemplary embodiment, may be used to identify or access a location of a person. The PPD 100 may be used by one spouse who is not able to get the other spouse to answer the phone. In such a situation, the called party may be assumed to be on call, and the caller desires to know where the called party is. According to an exemplary embodiment, the user seeking the called party may send a location request to a presence service provider server according to the present invention, and may use a Time to Tower algorithm to derive an approximate location of the user (e.g., the person is still at the office, on the way home, etc.). Alternatively, the user could send a quick text message that the other person may reply to, by simply picking from a list of possible common responses.

### Snap-On Enterprise Customizable Interface

According to an exemplary embodiment, the PPD 100 device may be customizable. For example, the PPD 100 may have a hardware interface to allow other devices to be modularly coupled to the PPD 100. For example, in an exemplary embodiment, a port such as, e.g., but not limited to, a USB interface, a Firewire Interface, or other access port may be provided. In an exemplary embodiment, accessories may be coupled to the PPD 100 including, e.g., a digital camera, a web cam, a printer, or other external peripheral accessory device.

According to one exemplary embodiment, radio frequency identifiers (RFIDs) may be used for position fixing and sensing movement. Rather than sense a location of a user at all time, like a GPS system does (which can use a lot of power and may not work indoors), an alternative location identification system may make use of RFID tags which may be placed in each of several locations where the user typically uses his or her mobile phone. The RFID tags might then be used to identify to the system the users location, either when the PPD 100 polls the tags, or the PPD 100 is made to communicate with the tag or other location identifier. Preferably using the RFIDs, the system may be a passive location identification system, and therefore will not take excessive batter usage.

While various exemplary embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to exemplary and preferred embodiments, it will be understood to those having ordinary skill in the art that changes in the above description or illustrations may be made with respect to formal detail without departing from the spirit and scope of the invention.

1-36. (canceled)

37. A telecommunications system comprising:
a telecommunications network;
a plurality of communication devices, associated with an End User, said End User communication devices interconnected with said telecommunications network;
a telecommunications server interconnected with said telecommunications network; and
an End User interface device wirelessly interconnected with said telecommunications network;
said End User interface device comprising:
configurable hot-keys enabling said End User to explicitly specify presence; and
a wireless data transmitter for transmitting said specified presence status to said telecommunications server via said telecommunications network;
said telecommunications server being operable to:
establish contextual parameters for said End User, including presence;
enable said End User to set up rules governing management of communications based on values for said contextual parameters; and
execute said rules, in view of a current contextual state and said specified presence status, to manage communications between said telecommunications network and said plurality of End User communication devices.

38. The system of claim 37, wherein said presence includes location, level of availability and mode for communication.

39. The system of claim 37, wherein said End User interface device and said telecommunications network communicate in a data/non-voice band.

40. The system of claim 37, further comprising:
a desktop PC in communication with said telecommunications server;
said desktop PC supporting a software application operable to:
enable said End User to specify said rules;
interface desktop context information to said telecommunications server; and
dictate call control between said telecommunications server and said plurality of End User communication devices.

41. The system of claim 37, wherein said rules comprise a hierarchy of rules and policies that allow for global and individual rules processing.

42. The system of claim 37, wherein said End User interface is operable to transmit instructions to said telecommunications server to perform a function selected from the group consisting of: transferring an ongoing call from a first one of said plurality of End User communication devices to a second one of said plurality of End User communication devices;
adding a calling party to a conference call;
putting a call on hold;
instructing said telecommunications server to place a telephone call from one of said plurality of End User communication devices;
changing a voicemail message being issued by one of said plurality of End User communication devices;
synchronizing locally stored PIM information with said telecommunications server;
organizing conference calls;
sending a wake-up/rescue call at a given point in time or after a specified duration has elapsed;
supporting a to-call list; and
displaying presence/availability/willingness of contacts including location information.

43. The system of claim 37, wherein said End User interface device further comprises:
a data receiver for receiving announcements from said telecommunications server; and
a display for displaying said received announcements.

44. The system of claim 37, wherein said End User interface device further comprises:
means for detecting the current physical location of said End User; and
a transmitter for transmitting said current physical location of said End User to said telecommunications server.

45. The system of claim 44, wherein said means for detecting the current physical location of said End User comprises a set of technologies selected from the group consisting of GPS, WiFi, and RFID.

46. The system of claim 37, wherein said telecommunications server and said End User interface device communicate via a signaling protocol selected from the group consisting of:
MGCP;
SIP; and
RTP.

47. The system of claim 37, wherein communications between said End User interface device and said telecommunications server are encrypted.

48. The system of claim 37, wherein communications between said End User interface device and said telecommunications server are effected over a secure communications link.

49. The system of claim 37, wherein said telecommunications server is operable to detect End User communication patterns.

50. The system of claim 49, wherein said telecommunications server is operable to use said detected patterns to modify the End User's rules.

51. The system of claim 49, wherein said telecommunications server is operable to use said detected patterns to suggest modifications to the End User's rules.

52. The system of claim 37, wherein said telecommunications server is operable to respond to entry of a “call break through” code by a calling party, by interrupting an End User communication that is currently underway.

53. The system of claim 37, wherein said plurality of End User communications devices includes at least one selected from the group consisting of:
a cellular telephone;
a personal digital assistant;
a personal computer;
an Internet-ready telephone;
a voice over IP telephone; and
a television set-top box.

54. The system of claim 37, wherein said contextual parameters include at least one selected from the group consisting of:
day and time;
on/off hook status of said End User's communication devices;
current activity of said End User;
activity level of said End User's PC;
physical velocity of said End User;
ambient noise and environment; and
physical location of said End User.

55. A method of operation for a telecommunications system comprising the steps of:
providing a telecommunications network, a plurality of communication devices associated with an End User, said End User communication devices interconnected with said telecommunications network, a telecommunications server interconnected with said telecommunications network, and an End User interface device wirelessly interconnected with said telecommunications network;
enabling said End User to explicitly specify presence status to said telecommunications server using configurable hot-keys on said End User interface device;
transmitting said specified presence status to said telecommunications server via a wireless data transmitter in said End User interface device; and
in said telecommunications server:
establishing contextual parameters for said End User, including presence;
enabling said End User to set up rules governing management of communications based on values for said contextual parameters; and
executing said rules, in view of a current contextual state and said specified presence status, to manage communications between said telecommunications network and said plurality of End User communication devices.

56. The method of claim 55, wherein said presence includes location, level of availability and mode for communication.

57. The method of claim 55, wherein said step of transmitting said specified presence status is effected in a data/non-voice band.

58. The method of claim 55, further comprising the steps of:
executing a software application on a desktop PC, said desktop PC being in communication with said telecommunications server;
enabling said End User to specify said rules;
interfacing desktop context information to said telecommunications server; and
dictating call control between said telecommunications server and said plurality of End User communication devices.

59. The method of claim 55, wherein said rules comprise a hierarchy of rules and policies that allow for global and individual rules processing.

60. The method of claim 55, further comprising the step of said End User interface transmitting instructions to said telecommunications server to perform a function selected from the group consisting of:
transferring an ongoing call from a first one of said plurality of End User communication devices to a second one of said plurality of End User communication devices;
adding a calling party to a conference call;
putting a call on hold;
instructing said telecommunications server to place a telephone call from one of said plurality of End User communication devices;
changing a voicemail message being issued by one of said plurality of End User communication devices;
synchronizing locally stored PIM information with said telecommunications server;
organizing conference calls;
sending a wake-up/rescue call at a given point in time or after a specified duration has elapsed;
supporting a to-call list; and
displaying presence/availability/willingness of contacts including location information.

61. The method of claim 55, further comprising the steps of:
said telecommunications server transmitting an announcement to said End User interface device;
said End User interface device receiving said announcement from said telecommunications server using a data receiver, and displaying said received announcement on a display.

62. The method of claim 55, further comprising the steps of:
said End User interface device detecting the current physical location of said End User, and transmitting said current physical location of said End User to said telecommunications server.

63. The method of claim 62, wherein said step of detecting the current physical location of said End User is effected using a set of technologies selected from the group consisting of GPS, WiFi, and RFID.

64. The method of claim 55, wherein said steps of transmitting are effected via a signaling protocol selected from the group consisting of:
MGCP;
SIP; and
RTP.

65. The method of claim 55, wherein said steps of transmitting are effected in an encrypted form.

66. The method of claim 55, wherein said steps of transmitting are effected over a secure communications link.

67. The method of claim 55, further comprising the step of said telecommunications server detecting End User communication patterns.

68. The method of claim 67, further comprising the step of using said detected patterns to modify the End User's rules.

69. The method of claim 67, further comprising the step of using said detected patterns to suggest modifications to the End User's rules.

70. The method of claim 55, further comprising the step of responding to entry of a “call break through” code by a calling party, by interrupting an End User communication that is currently underway.

71. The method of claim 55 wherein said plurality of End User communications devices includes at least one selected from the group consisting of:
a cellular telephone;
a personal digital assistant;
a personal computer;
an Internet-ready telephone;
a voice over IP telephone; and
a television set-top box.

72. The method of claim 55 wherein said contextual parameters include at least one selected from the group consisting of:
day and time;
on/off hook status of said End User's communication devices;
current activity of said End User;
activity level of said End User's PC;
physical velocity of said End User;
ambient noise and environment; and
physical location of said End User.
